(19) United States
(12) Patent Application Publication
(10) Pub. No.: US 2006/0194102 A1
(43) Pub. Date: Aug. 31, 2006

(54) Resistive balance for an energy storage device

(76) Inventors: Sarkis Keshishian, Ermington (AU); Geoffrey Alan Turner, Lane Cove (AU); George Lange Paul, Chatswood West (AU); Calum John Drummond, Balmain Nsw (AU)

Correspondence Address: KENYON & KENYON LLP, 1500 K STREET N.W., SUITE 700, WASHINGTON, DC, 20005, US

(21) Appl. No.: 10/543,653

(22) PCT Filed: Feb. 13, 2004
(86) PCT No.: PCT/AU04/00171

§ 371 Date: Mar. 17, 2006

(30) Foreign Application Priority Data
Feb. 13, 2003 (AU) 2003900633

(51) Int. Cl. H01M 2/24

(52) U.S. Cl. 429/160; 429/7

(57) ABSTRACT

A resistive balance (1) for an energy storage device in the form of a supercapacitor (2). The supercapacitor has two energy storage cells (3, 4). In some embodiments, the balance is disposed intermediate the cells. Balance (1) includes two parallel, spaced apart and co-extensive longitudinal members (5, 6) that respectively extend between ends (7, 8) and ends (9, 10). Two parallel, spaced apart and co-extensive transverse members (11, 12) extend between members (5, 6). While member (11) is attached to members (7, 8) immediately adjacent to ends (7, 9) respectively, member (12) is attached to members (7, 8) adjacent to but spaced inwardly from respective ends (8, 10).

### FIELD OF THE INVENTION

The present invention relates to a resistive balance and in particular to a resistive balance for an energy storage device.

The invention has been developed primarily for use with a supercapacitor and will be described hereinafter with reference to that application. However, the invention is not limited to that particular field of use and is also suitable for other energy storage devices such as capacitors, fuel cells, primary batteries, secondary batteries, hybrids of these devices and the like.

The terms “supercapacitor” and “supercapacitors”, as used in this specification, are intended to encompass electric double layer capacitors, hybrid devices including such capacitors, and similar energy storage devices. Supercapacitors are also referred to as ultracapacitors, electrochemical capacitors, double layer capacitors or the like.

### DISCUSSION OF THE PRIOR ART

Any discussion of the prior art throughout the specification should in no way be considered as an admission that such prior art is widely known or forms part of common general knowledge in the field.

Known forms of energy storage devices, such as supercapacitors, include a housing, two or more electrodes disposed within the housing in a spaced apart configuration for defining at least one energy storage cell and two or more terminals that are connected to selected one or more of the electrodes and which extend from the housing for allowing external electrical connection to the electrodes.

One type of supercapacitor includes opposed electrodes immersed in an electrolyte where the electrodes are maintained in a predetermined, spaced-apart, electrically isolated configuration. In some cases, the electrodes are so maintained by an intermediate insulating separator. In other cases, the separator and the electrolyte are integrated. At least one of the electrodes provides a surface on which an electric double layer is formed at the electrode-electrolyte interface. Typically the electrode includes a current collector that is composed of a conductive substrate. While the substrate is generally a metal, such as a metal sheet, in other known devices different conductive materials are used. The substrate preferably has a large surface area to provide the supercapacitor with the large capacitance. One way of providing that large surface area is to coat the substrate with a high surface area material. The coating is typically formed from one or more forms of carbon—be that carbon fibres, particulate carbon, carbon nano-tubes or the like—and a binder for adhering the carbon to itself and the current collector. Other materials can be used to provide an electrode with the high surface areas such as organic molecules—such as polymers—and inorganic compounds—such as metal oxides, metal hydroxides, and metal phosphates. Accordingly, the electrodes collectively form a single energy storage cell.

The electrodes and, where used, the intermediate separator are either stacked or wound together, and are disposed within a housing that contains to electrolyte. The electrolyte contains ions that are able to freely move throughout a matrix, such as a liquid or a polymer, and respond to the charge developed. on the electrode surface. Further, respective terminals are part of, or connected to, and extend from the respective electrodes to permit external access to them. Finally, the housing is sealed to prevent the ingress of contaminants and the egress of the electrolyte.

The supercapacitor stores energy in the electric field that extends across the electric double layer. Where one or more of the electrodes stores charge in the electric double layer, and one or more electrodes stores charge by electrochemical reaction, this type of device is known as a “hybrid supercapacitor”.

In other configurations, two or more of such cells are connected in parallel and/or series between the terminals to provide a desired operational voltage, current capacity, and/or capacitance.

In use, the voltage that is able to be practically applied across a single cell is limited and, therefore, it is not unusual to include a plurality of cells connected in series. In higher voltage applications this occurs as a matter of course. However, it is also known to do so for low voltage applications to provide a greater operational safety factor. For higher current applications, a plurality of cells are connected in parallel.

By way of further explanation, it is mentioned that the breakdown voltages of the components within a supercapacitor contribute to the operating voltage of that supercapacitor. Typically, the limitations to the operating voltage are the properties of one or more of the following components used with a supercapacitor; the electrolyte salt; the electrolyte solvent; the electrode coating; the current collector; the separator; and the packaging. For alternative supercapacitor constructions there are also other factors inherent in their design.

The breakdown voltage of the cell itself—that is, the lowest voltage that will cause the cell to fail—is determined by the lowest of the breakdown voltages of its components. The conventional approach to increasing the breakdown voltage of a cell is to use components with greater voltage stability. For example, some known devices use non-aqueous solvents to increase the operating voltage of the cell.

A supercapacitive cell typically has an operating voltage that is provided by the manufacturer of that cell. For multiple cell supercapacitors, the operating voltage is more often expressed as a voltage for a supercapacitor as a whole. There is a desire to increase this operating voltage as this not only contributes to the electrical performance of the supercapacitor, as will be discussed further below, but also allows less series connected cells for a given application voltage.

The operating voltage is typically a nominal figure based upon the breakdown voltage for the cell or cells, together with regard to the safety margins being designed into the cell, and the lifetime requirements of the call. Some cells are able to be exposed, for short periods, to voltages greater than the operating voltage, without adverse effects. However, prolonged exposure will usually degrade the short-term performance characteristics of the cell, as well as shortening its likely operating lifetime.

If uniform coats are assumed, the capacitance (C) that is gained from a capacitor of the above type is proportional to the surface area of the smallest electrode. It is appreciated that capacitors may be formed in many arrangements, and that capacitance is measured for each electrically separate cell. Further, cells maybe connected in series and/or parallel.

The energy storage capacity for a capacitor is described by the following equation:

$$E = \frac{1}{2} {CV}^{2} \qquad Equation 1$$

where E is the energy in Joules, C is the capacitance in Farads and V is tie operating voltage of the capacitor.

Another measure of supercapacitor performance is the ability to store and release energy rapidly—this is the maximum power, P, of a capacitor—which is given by:

$$P = \frac{{V}^{2}}{4 R} \qquad Equation 2$$

where R is the internal resistance of the supercapacitor.

The internal resistance, R, is commonly referred to as the equivalent series resistance, or “ESR”. That is, the ESR is the sum of the resistance of all the components of the supercapacitor through which current flows between the external contacts or terminals. Further, the ESR of a device, or of an individual component of a device, is defined as the real component of the impedance at 1,000 Hz.

Importantly, and as indicated in Equation 2, the power performance of a supercapacitor is dependent upon the ESR. Further, a significant contributor to a supercapacitor's ESR is the native oxide coating that forms on electrodes comprised of metals, such as aluminum. Therefore, it is known to treat that native oxide layer as a means for reducing the ESR.

Supercapacitors have considerably more specific capacitance than conventional capacitors. When this characteristic is combined with a low resistance, such supercapacitors are ideally suited for high power applications for mobile devices, particularly those using GSM (Global System for Mobile communication), GPRS (General Packet Radio Service), EDGE (enhanced data rates for GSM evolution), UMTS (Universal Mobile Telecommunications Services), and 3G (Third generation) wireless technologies. Supercapacitors are also able to play a role in hundreds of other applications. The energy and power storage markets, where supercapacitors reside, are currently dominated by batteries and conventional capacitors. It is well recognised that batteries are good at storing energy but compromise design to enable high power delivery of energy. It is also well recognised that conventional capacitors enable fast (high power) delivery of energy, but that the amount of energy delivered is very low—due to the low capacitance available. Overlaying these limitations of existing batteries and capacitors against market demand reveals the three main areas of opportunity for supercapacitors: battery replacement—that is, devices which have higher energy density; battery complements—that is, devices which have high power and energy densities; and capacitor replacement—that is, devices which are smaller and not only have high power density but have high frequency response.

Currently, the relatively high power density of supercapacitors make them ideal for parallel combination with batteries that have high energy density to form a hybrid energy storage system. When a load requires energy that is not constant, complementing the battery with a supercapacitor allows the peaks to be drawn from the charged-up supercapacitor. This reduces the load on the battery and in many cases extends the lifecycle of a battery as well as the lifetime of rechargeable batteries.

Modern mobile devices require power systems that are capable of dealing with large fluctuations in the load. For example, a cellular telephone has a variety of modes each with a different load requirement. There is a stand-by mode, which requires low power and is relatively constant. However, this mode is periodically punctuated by the need to find the nearest base station and a signal is sent and received, requiring a higher load. In full talk mode where continuous contact to a base station is required, the load takes the form of a periodic signal where the instantaneous load is quite different from the average. A number of communication protocols exist, such as GSM and GPRS, but they are all characterized with a periodic load. The parallel supercapacitor-battery hybrid is particularly suited to this application because the power from the supercapacitor is used during the high loads that are usually short in duration and the energy from the battery can recharge the supercapacitor and supply a base load during the time of low power demand. As further miniaturization of digital wireless communication devices occurs, leading to decreased battery sizes, the need for supercapacitors will increase.

Supercapacitors also have application in the field of Hybrid Electric Vehicles HEV). Supercapacitors are able to be used as an integral component of the drivetrains of these vehicles and are used as the primary power source during acceleration and for storage of energy reclaimed during regenerative braking. Such vehicles could conceivably halve a motorist's fuel bill and slash emissions by up to 90%.

In general terms, capacitance arises when two parallel plates are connected to an external circuit and a voltage difference is imposed between the two plates, the surfaces become oppositely charged. The fundamental relationship for this separation of charges is described by the following equation

$$C = \frac{ɛ A}{L} \qquad Equation 3$$

where C denotes capacitance with a unit of farads (F), ε is the permittivity with a unit of Farads per metre (m), A is the area of overlap of the charged plates and L is the separation distance. The permittivity of the region between the plates is related to the dielectric constant of the material that can be used to separate the charged surfaces.

The problem with existing commercial capacitors using conventional materials is that their performance is limited by their dimensions. For example, a capacitor based around a metallized coating of a polyethylene sheet that is 50 μm thick will develop only 0.425 μF for one square metre of capacitor. Thus, over 2.3 million square metres will be required to develop 1 F.

The supercapacitors developed by the present applicant are disclosed in detail in the applicant's co-pending applications, for example, PCT/AU98/00406, PCT/AU99/00278, PCT/AU99/00780, PCT/AU99/01081, PCT/AU00/00836, PCT/AU01/00553, PCT/AU01/00838, and PCT/AU01/01613, the contents of which are incorporated herein by reference.

These supercapacitors developed by the applicant overcome the dimensionality problem described above by using as a coating material an extremely high surface area carbon.

In supercapacitors, the separation distance of charges is generally very small—typically less than a nanometre—which, when combined with a very high surface area, provides for a high capacitance. (Reference is made to Equation 3). This is where the technological advantage for supercapacitors over conventional capacitors lies, as charge storage in the extremely thin layer gives rise to specific capacitances of approximately 0.1 Fm⁻². This is an increase by several hundred thousand-fold over conventional film capacitors. As well, the applied potential controlled, reversible nanoscale ion adsorption/desorption processes result in a rapid charging/discharging capability for supercapacitors.

As suggested above, some supercapacitors make use of an electrode coating of highly porous carbon particles with a very high surface area. For example, surface areas may range from 100 m² per gram, up to greater than 2500 m² per gram in certain preferred embodiments. The colloidal carbon matrix is held together by a binding material that not only holds the carbon together (cohesion) but it also has an important role in holding the carbon layer onto the surface of the current collecting substrate (adhesion).

The current collecting substrate is generally a metal foil, although this does vary between types of devices.

One variable of interest in the field of supercapacitors is the nature of the electrolyte involved. The electrolyte is typically one or more solvents containing one or more dissolved ionic species. In many cases, the physical and electrochemical properties of electrolyte are a key factor in determining the internal resistance (ESR) of the supercapacitor and the “power spectrum” of the supercapacitor, that is, the ability of the supercapacitor to provide power over various time domains or in various frequency ranges.

The factors influencing the conductance (κ) of an electrolyte solution are described in detail in an article by B. E. Conway taken from “The Fourth International Seminar on Double Layer Capacitors and Similar Energy Storage Devices”, Dec. 12-14, 1994, held ; Ocean Resort Hotel and Conference Centre, Deerfield Beach, Fla. and co-ordinated by Florida Educational Seminars, Inc., 1900 Glades Road, Suite 358, Boca Raton, Fla. 33431.

In summary, there are two principal factors which are involved in determining the conductance—these are:
a) the concentration of free charge carriers, cations and anions; and
b) the ionic mobility or conductance contribution per dissociated ion in the electrolyte.

There are a number of sub-factors that, in turn, influence these two principal factors. These are:
a) The solubility of the selected salt.
b) The degree of dissociation into free ions and factors such as the extent of ion-pairing of the ionic species. This in turn is influenced by the salt concentration, temperature and the dielectric constant of the solvent.
a) The viscosity of the solvent, which is a temperature dependent property. As temperature increases, there is a corresponding decrease in viscosity.

Solvents for supercapacitors can thus be designed with the following criteria in mind:
a) Solvent for selected ionic species
b) Degree of dissociation of cation/anion pairing in solution
c) Dielectric constant
d) Electron-pair donicity
e) Permits high ion mobility
f) Extent of solvation of fee ions and radii of solvated ions
g) Temperature coefficient of viscosity (ie low viscosity in the intended temperature range)
h) and ion paring equilibria.

There is also the necessity for the solvent to be chemically stable. Aqueous based electrolytes, such as sulfuric acid and potassium hydroxide solutions, are often used as they enable production of an electrolyte with high conductivity. However, water is susceptible to electrolysis to hydrogen and oxygen on charge and as such has a relatively small electrochemical window of operation outside of which the applied voltage will degrade the solvent. To maintain electrochemical stability in applications requiring a voltage in excess of 1.5V, it is necessary to employ supercapacitor cells in series, which leads to an increase in size in relation to non-aqueous devices. Stability is important when one considers that the supercapacitors must charge and discharge many hundreds of thousands of times during the operational lifetime of the supercapacitor.

There are of course processing requirements on the solvent also, such as cost, toxicity, purity and dryness considerations.

Non aqueous solvents commonly used in related fields, for example, batteries, can be classified as: high dielectric constant aprotic (e.g. organic carbonates), low dielectric constant with high donor number (e.g. dimethoxyethane, tetrahydrofuran or dioxolane), low dielectric constant with high polarisability (e.g. toluene or mesitylene) or intermediate dielectric constant aprotic (e.g. dimethylformamide, butyrolactone) solvents.

However, in addition to the specific electrolyte requirements of supercapacitors mentioned above, there is also the practical consideration that supercapacitors do not operate in isolation. Rather, in use, they are in confined environments in the presence of components which generate high temperatures, and like the other components, this must be borne in mind when selecting the electrolyte solvent. Also, it needs to be borne in mind that the supercapacitors must be capable of operation at start-up at temperatures much lower (even into the sub zero range) than the high operating temperatures referred to above.

The energy storage of batteries, in contrast to the power delivery of supercapacitors, is not critically dependent on the contribution of the electrolyte to the ESR of the cell, although even in batteries, low ESR is desirable. Solvents which have high boiling points invariably have high viscosities, and consequently, low charge mobilities at low temperatures. High boiling solvents, such as cyclic ethers and lactones can therefore be used in batteries with less regard to what would be an unacceptably high ESR in supercapacitors.

These, and other considerations, are set out in more detail in co-pending application PCT/AU03/00334, the contents of which are incorporated heroin by way of cross-reference.

The above discussion illustrates the variety of actors that go into the design of a supercapacitor for any given application. However, with those applications that require series combinations of supercapacitors additional complications arise. Particularly, due to manufacturing tolerances—and the need to balance tolerances with cost—there inevitably arises a lack of uniformity between notionally like supercapacitors. That is, any given measurable characteristic of the devices, while falling within given tolerances, will be distributed between those tolerances. The problems arising from this lack of uniformity between supercapacitors that are to be connected in series are outlined in papers by:
a) John R. Miller entitled “Electrochemical Capacitor Voltage Balance—Cell Uniformity Requirements for High-Voltage Devices” as included in the Proceedings of the 36th International Power Sources Symposium, Cherry Hill, N.J., p 15-18 (June 1994).
b) John R. Miller ad Susannah M. Butler entitled “Electrochemical Capacitor Float-Voltage Operation: Leakage Current Influence On Cell Voltage Uniformity” presented to the 11^{th} International Seminar on Double Layer Capacitors And Similar Energy Storage Devices”, Deerfield Beach, Fla., Dec. 3-5, 2001.
c) B. E. Conway entitled “Characterization And Behavior And Mechanisms Of Self-Discharge Of Electrochemical Capacitors In Relation To That At Batteries” presented to The Fifth International Seminar On Double Layer Capacitors And Similar Energy Storage Devices, Boca Raton, Fla., Dec. 4-6, 1995.

It will be appreciated that a supercapacitor includes one or more series connected cells. For a given operational voltage, there will be a need for a certain number of those cells based upon the operating voltage of the cells. Whether those cells are packaged in a single supercapacitor, or a number of series connected supercapacitors, is of less significance. In either case, there are, in affect, a plurality of supercapacitive cells connected in series. Each of the cells in the series has a number of electrical properties, including:
a) A charge current is the current used to charge a cell up to its operating voltage (V₀).
b) A charge storage current is the reducing current which flows into a cell in a predetermined period immediately following the cell being held at the operating voltage. (Typically, the predetermined period is tens of hours).
c) A leakage current (I_{L} ) is the reducing current which flows into a cell when it is held at the operating voltage beyond the predetermined period.
d) An equivalent parallel resistance (EPR) which is the resistance defined by:
   EPR=V₀/I_{L} Equation 4
e) A time constant—also known as an RC time constant—is equal to the product of the ESSR and the capacitance,
f) A response time (T₀), as defined in PCT/AU99/01081.
g) A volumetric and gravimetric FOM, as defined it PCT/AU99/01081.
h) A volumetric and gravimetric maximum power density, which are defined by Equation 2 per unit volume or mass respectively.
i) A volumetric and gravimetric energy density; which are defined by Equation 1 per unit volume or mass respectively.

It is also possible to categorise a supercapacitor—as opposed to a supercapacitive cell—in terms of these same properties.

Where use is made of a plurality of series connected cells—regardless of whether those cells are in the same or a number of supercapacitors—each of the cells will have different values for the above properties, even if those differences are small. In partial answer to this, it has been known to “match” cells that are intended for series connection. Typically, the properties being matched are leakage current, capacitance and ESR. However, this is dependent upon the critical performance parameters for a given application.

Matching nominally like cells or nominally like supercapacitors is typically based upon static and controlled conditions and, as such, is limited in effectiveness.

The above properties for a given cell are known to change with time, the temperature of a cell, and the voltage to which a cell is exposed. Accordingly, even for those cells that are thought to be well matched at the time of manufacture, they will not necessarily so remain as to cell is put into use. This is exacerbated by the fact that, for some of to properties referred to above, once a difference manifests sufficiently, it has the effect of increasing that difference.

By way of example, for a plurality of series connected supercapacitive cells, each of the cells has a unique equivalent parallel resistance (EPR) based upon its physical make up—including any impurities and its chemistry—for a given temperature and voltage across the call. If the cells in the series experience, during use, a temperature change this typically results in a change to the EPR which is unlikely to be the same for each cell. Accordingly, well matched cells are easily able to become poorly matched due to environmental influences such as temperature change, mechanical stresses, and the like. This effect is exacerbated where the cells in the series are subject to differentials in environmental effects. An instance of this occurs with stacked cells, where the cell on the bottom of the stack is preferentially heated due to its relative proximity to a heat source such as a processor or other circuitry or components.

In the circumstances referred to above, a temperature differential will result in a greater differential between the EPR's of the cells in the series, even if all are well matched beforehand. This, in turn, will change the relative proportion of the application voltage that is seen by each cell and, hence, will increase the risk of failure of the cell that is seeing a higher proportion. Even if the voltage seen by a cell does not approach the breakdown voltage of that cell, there is still the danger that it will exceed the operating voltage and thereby compromise the reliability and lifetime of the cell.

### DISCLOSURE OF THE INVENTION

It is an object of the present invention to overcome or ameliorate at least one of the disadvantages of the prior art, or to provide a useful alternative.

According to a first aspect of the invention there is provided a resistive balance for an energy storage device having at least two energy storage cells, the balance being disposed intermediate the cells.

Preferably, the cells are serially connected and balance includes a plurality of resistive paths in parallel with the respective cells. More preferably, the balance includes a plurality of resistive members for defining the respective paths. That is, the paths are uniformly resistive along their respective lengths. In other embodiments, however, the paths each include separate conductive portions that are connected by resistive portions. In further embodiments, the balance includes one or more active components.

Preferably also, the resistive portions are surface mount resistors. More preferably, the resistors are electrically connected to the adjacent conductive portions by solder, conductive adhesive or other means. In other embodiments, the active components awe surface mounted.

Preferably, one of the cells includes a first terminal and a second terminal, wherein the first terminal defines a negative terminal for the device. More preferably, the other of the cells includes a third terminal and a fourth terminal, wherein the fourth terminal defines a positive terminal for the device and the second terminal is electrically connected to the third terminal.

Preferably also, the balance includes:

a frame that extends between a first end and a second end;

a first tab that extends from the first end for connecting with the first terminal;

a second tab that is spaced apart from the first tab and which extends from the first end for connecting with the fourth terminal; and

a third tab that extends from the second end for connecting with the second and third terminals.

More preferably, one of the paths extends along the balance between the first tab and the second tab, and another of the paths extends along the balance between the second tab and to third tab. More preferably, the conductive portions are metal tracks and the resistive portions are resistors that bridge between the metal tracks. In other embodiments, however, the resistive portions are defined by one or more active components and one or more resistors. It will be appreciated that in some embodiments the active components include one or more operational amplifiers.

In a preferred form, the first, second and third tabs are electrically connected to a board such that the board defines respective resistive paths between the first and the second terminals and the third and the fourth terminals. More preferably, the resistance of the resistive paths is substantially equal. In other embodiments, the resistance of the resistive paths is varied over time. Preferably, the resistance is varied in response to the voltage across one or more of the cells.

Preferably, the balance is sandwiched between the cells. More preferably, the balance is sandwiched wholly between the cells.

In some embodiments, the balance is one or more laminar sheets. More preferably the sheet is coated with a non-conductive adhesive. Even more preferably, the sheet is laminar. In some embodiments the sheet includes two outer layers of a first resistance and an intermediate layer of a second resistance that is much greater than the first resistance.

In a preferred form, one of the calls includes a first terminal and a second terminal, wherein the first terminal defines a negative terminal for the device. More preferably, the other of the cells includes a third terminal and a fourth terminal, wherein the fourth terminal defines a positive terminal for the device and the second terminal is electrically connected to the third terminal.

Preferably, the balance includes a cradle onto which the cells are mounted. More preferably, the cradle includes a plurality of resistive members for defining the respective paths. Even more preferably, the paths each include separate conductive portions that are connected by resistive portions. In other embodiments, however, the paths are substantially uniformly resistive. In further embodiments, the resistance of the resistive paths varies in response to the voltage across at least one of the cells.

According to a second aspect of the invention there is provided an energy storage device having two energy storage cells that each include two terminals, the device including:

a first contact that is connected to one of the terminal of one of the cells;

a second contact that is connected to one of the terminals of the other of the cells;

a third contact that is connected to the others of the terminals; and

two resistive paths that extend between the first contact and the third contact and the second contact and the third contact respectively for collectively defining a resistive balance for the device.

Preferably, the balance is mounted to a substrate. More preferably, the substrate is a circuit board. Even more preferably, the resistance of the resistive paths is substantially equal and the first and second contacts arc fixedly electrically connected to the board. In other embodiments, the resistive paths are defined by one or more active components. Preferably, the active components are mounted to the circuit board. More preferably, the active components are surface mounted to the circuit board.

Preferably also, the balance is disposed intermediate the cells. More preferably, the balance is sandwiched between the cells. More preferably, the balance is sandwiched wholly between the cells.

In a preferred form, the first contact defines a positive terminal for the device and the second contact defines a negative terminal for the device. More preferably, the third contact is electrically connected with the board.

Preferably, the device includes more than two cells.

According to a third aspect there is provided a circuit board including one or more energy storage devices, wherein that or those devices include a resistive balance of the first aspect of the invention.

According to a fourth aspect of the invention there is provided a circuit board for supporting a plurality of components that are electrically interconnected, wherein at least one of the components is an energy storage device having:

at least two serially connected energy storage cells, and

a resistive balance having a plurality of resistive paths in parallel with the respective cells.

In an embodiment, the resistive paths are defined by respective resistors. In other embodiments, however, the resistive paths are defined, at least in part, by one or more active components. Preferably, each resistive path is defined by a combination of one or more resistors and one or more active components.

According to a fifth aspect of the invention there is provided an electronic device including an energy storage device having:

at least two serially connected energy storage cells; and

a resistive balance having a plurality of resistive paths in parallel with the respective cells.

In an embodiment, the resistive paths are defined by respective resistors. In other embodiments, however, the resistive paths are defined, at least in part, by one or more active components. Preferably, each resistive path is defined by a combination of one or more resistors and one or more active components.

According to a sixth aspect of the invention there is provided a cradle for an energy storage device having at least two energy storage cells, the cradle being disposed intermediate the cells.

Preferably, one of the cells includes a first terminal and a second terminal, wherein the first terminal defines a negative terminal for the device. More preferably, the other of the cells includes a third terminal and a fourth terminal, wherein the fourth terminal defines a positive terminal for the device and the second terminal is electrically connected to the third terminal.

Preferably also, the cradle includes:

a frame that extends between a first end and a second end;

a first tab that extends from the first end for connecting with the first terminal;

a second tab that is spaced apart from the first tab and which extends from the first end for connecting with the fourth terminal; and

a third tab that extends from the second end for connecting with the second and third terminals.

More preferably, one of the paths extends along the cradle between the first tab and the third tab, and another of the paths extends along the cradle between the second tab and the third tab. More preferably, the conductive portions are metal tracks and the resistive portions are resistors that bridge between the metal tracks. In other embodiments, however, the resistive paths are defined, at least in part, by one or more active components. In further embodiments, the resistive paths are defined by a combination of one or more resistors and one or more active components.

In a preferred form, the first, second and third tabs are electrically connected to a board such that the board defines respective resistive paths between the first and the second terminal and the third and the fourth terminal. More preferably, the resistance of the resistive paths is substantially equal. In some embodiments, the resistance of the resistive paths is varied in response to the voltage across one or more of the cells.

According to a seventh aspect of the invention there is provided a cradle for an energy storage device having at least two serially connected energy storage cells, the cradle being disposed intermediate the cells and having a plurality of resistive paths in parallel with the respective cells to define a resistive balance.

Preferably, the cradle is sandwiched between the cells. More preferably, the cradle includes tabs that extend outwardly from between the cells. Even more preferably, the tabs facilitate electrical connection of the cells to external electrical components. In the preferred embodiments, the tabs are adapted for connection to a circuit board. However, in other embodiments, the tabs are adapted for direct connection to external electrical components.

In a preferred form, one of the cells includes a first terminal and a second terminal, wherein the fist terminal defines a negative terminal for the device. More preferably, the other of the cells includes a third terminal and a fourth terminal, wherein the fourth terminal defines a positive terminal for the device and the second terminal is electrically connected to the third terminal.

Preferably, the cradle includes a plurality of resistive members for defining the respective paths. More preferably, the paths each include separate conductive portions that are connected by resistive portions. In other embodiments, however, the paths are substantially uniformly resistive. In other embodiments, the resistive members include one or a combination of one or more resistors and one or more active components.

According to an eighth aspect of the invention there is provided a cradle for an energy storage device having two energy storage calls that each includes two terminals, the cradle including:

a first contact that is connected to one of the terminal of one of the cells;

a second contact that is connected to one of the terminals of the other of the cells; and

a third contact that is connected to the others of the terminals.

Preferably, the cradle is mounted to a substrate for electrically interconnecting the contacts. More preferably, the substrate is a circuit board. Even more preferably, the contacts are electrically interconnected such that the board defines respective resistive paths between the first and the third contact and the second and third contact. In the preferred embodiments, the resistance of the resistive paths is substantially equal. In other embodiments, the resistance of the resistive path is varied in response to the voltage across at least one of the cells.

Preferably also, the cradle is disposed intermediate the cells.

In a preferred form, the first contact defines a positive terminal for the device and the second contact defines a negative terminal for the device. More preferably, the third contact is electrically connected with the board.

According to a ninth aspect of the invention there is provided a resistive balance for at least two series connected energy storage devices, the balance being connected in parallel with the devices and having a high power consumption mode for progressing the devices toward a balanced state and a low power consumption mode when the devices are in the balanced state.

Preferably, each of the devices has a voltage across it wherein, in the balanced state, the voltages across the devices are substantially equal. In some embodiments, the voltages across the devices in the balanced state differ by less than a predetermined threshold. For example, in some embodiments, the threshold is about 0.5 Volts. However, in other embodiments, alternative thresholds are used.

Preferably, the energy storage device is a capacitor.

In an embodiment, in the low mode, the power consumed by the balance is less than 10% of the power consumed by the balance in the high mode.

Preferably also, each device includes a plurality of capacitors in parallel. In some embodiments, each device includes a plurality of capacitors in parallel and/or series.

Preferably, the balance is connected in parallel with more than two series connected devices. In some embodiments, the balance is cascaded with more than ten series connected devices. However, as embodiments of the invention are typically applied to low voltage circuits, use is made of less than ten series connected devices.

Preferably also, the balance toggles between the two modes. More preferably, the balance remains in the low mode until the devices have progressed from the balanced state by a predetermined amount. In other embodiments, however, the balance progressively transfers from one mode to the other.

In a preferred form, each of the devices includes two terminals, one of those terminals defining a positive terminal, another of those terminals defining a negative terminal, and the two remaining terminals defining a common terminal. More preferably, the balance includes a switching device that is connected with the positive, the common and the negative terminals for selectively defining current paths between the terminals to toggle the balance between the low and high modes.

Preferably, the switching device is responsive to the voltage between the positive terminal and the common terminal, and the voltage between the negative terminal and the common terminal for determining when to toggle between the low and the high modes. In other embodiments, the switching device is responsive to the voltage between the positive and negative terminals.

According to a tenth aspect of the invention there is provided a resistive balance for at least two series connected energy storage devices, the balance being, connected in parallel with the devices and having a low resistance mode for progressing the devices toward a balanced state and a high resistance mode when the devices are in the balanced state.

Preferably, the devices have respective equivalent parallel resistances (EPRs), and the balance, in the high resistance mode, provides an effective resistance in parallel with each device, wherein the effective resistance is greater than the respective EPR. More preferably, the effective resistance is at least 10 times greater than the respective EPR. Even more preferably, the effective resistance is at least 100 times greater than the respective EPR.

Preferably also, in the low resistance mode, the effective resistance across the devices at the higher voltage is less than the respective EPR. More preferably, the effective resistance is at least 10 times less than the respective EPR. Even more preferably, the effective resistance is at least 100 times less than the respective EPR. In other embodiments, however, the effective resistance is at least 10⁶ times less than the respective EPR.

The term “capacitor” as used in this specification refers to any passive charge storage device having an internal charge separation and thus an internal electric field. Typically, such devices also have a leakage current. This includes electrolytic capacitors, carbon double layer capacitors—otherwise known as supercapacitors, ultracapacitors, and the like. Where reference is made to a supercapacitor or capacitor, it will be understood, unless the context clearly requires otherwise, that this includes one such charge storage device or a number of such devices connected in parallel.

According to an eleventh aspect of the invention there is provided an electrical device including:

circuitry for providing a predetermined functionality,

a supply rail for providing power to the circuitry;

an energy storage device for energising the supply rail;

a plurality of series connected capacitors connected in parallel with the rail; and

a voltage balance device that is connected in parallel with the capacitors and having a low resistance mode for progressing the capacitors toward a balanced state and a high resistance mode when the capacitors are in the balanced state,

Preferably, the predetermined functionality includes wireless transmission.

According to a twelfth aspect of the invention there is provided a voltage balance for an energy storage device that experiences a load voltage, the balance being connected in parallel with the device and being responsive to predetermined values of the load voltage for partially discharging at least one of the devices.

Preferably, the discharging occurs through a resistor. That is, the balance has a high power consumption mode for partially discharging the energy storage device and otherwise a low power consumption mode.

Preferably also, the balance is connected in series with a plurality of like balances for providing voltage balancing for a corresponding plurality of series connected energy storage devices.

In a preferred form, the balance includes:

a resistive divider connected in parallel with the devices for providing a divided voltage derived from the load voltage;

a dissipation resistor;

a switch having a reference voltage, an input that is responsive to the divider voltage and an output that is connected to the dissipation resistor, wherein the switch is responsive to the divider voltage being greater than the reference voltage for allowing a current flow in the dissipation resistor to partially discharge the energy storage device.

Preferably, the dissipation resistor has a resistance of greater than zero.

Preferably, the switch is an operational amplifier. More preferably, the switch is a MAX9117 operational amplifier configured as a comparator. However, in other embodiments alternative amplifiers, and alternatively configured amplifiers, are used.

According to a thirteen aspect of the invention there is provided a voltage balance for an energy storage device that experiences a device voltage, the balance being connected in parallel with the energy storage device for maintaining the device voltage below a predetermined threshold.

Preferably, the device voltage is maintained below the threshold by partially discharging the energy storage device. More preferably, the balance includes a dissipation resistor and a variable resistance device that is responsive to predetermined values of the capacitor voltage for allowing the capacitor to partially discharge through the resistor. Even more preferably, the dissipation resistor has a voltage of greater than zero.

Preferably also, the variable resistance device is an operational amplifier having:

an internal voltage reference;

an input voltage that is responsive to the device voltage;

an output voltage that is applied to the dissipation resistor; and

a comparator that is responsive to the input and the internal reference voltage for determining the output voltage and, hence, the current flow in the resistor.

According to a fourteenth aspect of the invention there is provided an electrical device including;

circuitry for providing a predetermined functionality;

a supply rail for providing power to the circuitry;
an energy storage device for energising the supply rail;

a plurality of series connected capacitors connected in parallel with the rail and which experience respective capacitor voltages; and

a voltage balance that is responsive to predetermined values of the capacitor voltages for partially discharging the respective capacitors.

According to a fifteenth aspect of the invention there is provided a voltage balance for at least two series connected energy storage devices that have respective leakage currents, the balance being connected in parallel with the devices and being responsive to the difference in voltage across the devices for generating a dissipation current that is substantially equal to the difference in the leakage currents.

Preferably, the dissipation current flows through a resistor. More preferably, the balance includes a resistive divider for providing a reference voltage, and a voltage follower that is responsive to the reference voltage for generating the dissipation current.

Preferably also, the balance is for use with n energy storage devices where n≧2 and the resistive divider provides (n−1) reference voltages, wherein the balance includes (n−1) voltage followers that are responsive to respective (n−1) reference voltages for generating the dissipation current. More preferably, the dissipation current is substantially equal to the difference between the highest and the lowest leakage currents provided by the energy storage devices.

According to a sixteenth aspect of the invention there is provided a voltage balance for an energy storage device, the balance including:

a comparator that is responsive to the voltage across the device and a reference voltage for providing a control signal; and

a discharge circuit being responsive to the control signal for partially discharging the device to maintain the voltage across the device below a predetermined value.

Preferably, the predetermined value is derived from the reference voltage. More preferably, the predetermined value is equal to the reference voltage. However, in other embodiments, the predetermined value is a fixed proportion of the reference voltage.

Preferably also, the voltage across the balance is provided by a power supply that provides a supply voltage, and the reference voltage is independent of the supply voltage.

In a preferred form, the ratio of the power consumed by the balance when discharging and not discharging the energy storage device is at least 10:1. More preferably, the ratio is at least 100:1.

According to a seventeenth aspect of the invention there is provided a voltage balance for a plurality of series connected energy storage devices, the balance including a plurality of the balances of the fifteenth aspect connected in parallel with respective energy storage devices.

According to an eighteenth aspect of the invention there is provided an energy storage device including two energy storage cells, the cell being connected in series and, in use, having respective cell voltages that are biased toward equality.

According to a nineteenth aspect of the invention there is provided an energy storage device including two energy storage cells, the cells being connected in series and, in use, having respective cell voltages that are biased toward predetermined values.

Preferably, the predetermined values are equal.

In an embodiment, the device includes more than two cells. Preferably, all the cells are connected in series. However, in some embodiments, at least one of the cells is connected in parallel with another cell.

Preferably, the device includes two series connected cells and has one or a combination of the following characteristics:

a thickness of less than about 5 mm;

a footprint of less than about 700 mm² not including protruding terminals;

a volume of less than about 3 ml;

an ESR of less than about 400 mΩ;

a product of ESR and thickness of less than about 700 mm.mΩ;

a product of ESR and volume of less than about 350 ml.mΩ;

a DC-capacitance of greater than about 0.03 Farads;

a weight of less than about 5 grams;

an operating voltage of greater than about 1.8 Volts;

a time constant of less than about 0.23 seconds;

a response time (T₀) of less than about 1.5 seconds;

a gravimetric FOM of greater than about 2.1 kW/kg;

a gravimetric power density of greater than about 6.6 kW/kg;

a gravimetric energy density of greater than about 0.08 Wh/kg,

a volumetric FOM of greater than about 3.2 kW/litre;

a volumetric power density of greater than about 10 kW/litre; and

a volumetric energy density of greater than about 0.1 Wh/litre.

Preferably, the thickness is less than about 4.5 mm. More preferably, the thickness is less than about 2.5 mm, and even more preferably, less than about 2.1 mm.

In a preferred form, the footprint excluding protruding terminals is less than or equal to about 17 mm×28.5 mm.

Preferably, the product of ESR and thickness is less than 300 mm.mΩ. More preferably, the product of ESR and thickness is less than about 200 mm.mΩ. Even more preferably, the product of ESR and thickness is less than about 100 mm.mΩ.

In a preferred form, the product of ESR and volume is less than about 200 ml.mΩ. More preferably, the product of ESR and volume is less than about 100 ml.mΩ.

Preferably also, the volume is less than about 2 ml. In other embodiments, the volume is less than about 1 ml.

Preferably, the ESR is less than about 100 mΩ. More preferably, the ESR is less than about 60 mΩ.

Preferably also, the DC-capacitance is greater than 0.1 Farads. More preferably, the DC-capacitance is greater than about 0.5 Farads. Even more preferably, the DC-capacitance is greater than about 1 Farad.

In a preferred form, the weight is less than about 4 grams. More preferably, the weight is less than about 2 grams.

Preferably, the operating voltage is greater than about 2 Volts, More preferably, the operating voltage is greater than about 3 Volts. Even more preferably, the operating voltage is greater than about 4 Volts.

Preferably, the time constant is less than about 0.1 seconds, More preferably, the time constant is less than about 0.03 seconds. Even more preferably, the time constant is less than about 0.01 seconds.

Preferably, the response time (T₀) is less than about 1 second. More preferably, the response time (T₀) is less than about 0.2 seconds.

Preferably also, the gravimetric FOM is greater than about 3.4 kW/kg, and more preferably greater than about 5 kW/kg. Even more preferably, the gravimetric FOM is greater than about 10 kW/kg.

Preferably also, the gravimetric power density is greater than about 10 kW/kg, and more preferably greater than about 15 kW/kg. Even more preferably, the gravimetric FOM is greater then about 30 kW/kg.

In a preferred form, the gravimetric energy density of greater than about 1 Wh/kg, and more preferably greater than about 2 Wh/kg.

Preferably, the volumetric FOM is greater than about 5 kW/litre, and more preferably, is greater than about 8 kW/litre. Even more preferably, the volumetric FOM is greater than about 20 kW/litre.

Preferably, the volumetric power density is greater than about 16 kW/litre, and more preferably, is greater than about 25 kW/litre. Even more preferably, the volumetric power density is greater than about 50 kW/litre.

Preferably, the volumetric energy density is greater than about 1 Wh/litre. More preferably, the volumetric energy density is greater than about 2 Wh/litre.

In some embodiments, the device includes a balance that is mounted together with the cells for providing the voltage bias toward equality. One such embodiment includes resistive paths extending in parallel with the respective cells.

According to a twentieth aspect of the invention there is provided an energy storage device, the device including:

two energy storage cells connected in series wherein each cell, in use, is exposed to a respective cell voltage; and

a balance for electrically connecting with the cells and for biasing the cell voltages toward equality.

Preferably, the cells have operating voltages. More preferably, the operating voltages are substantially equal. Even more preferably, the operating voltages are greater than about 2.3 Volts. More preferably, the operating voltage is greater than about 2.5 Volts. Even more preferably, the operating voltages are greater than about 2.7 Volts. Preferably also, the operating voltage is less than about 5 Volts.

Preferably also, the balance also contains the cell voltages below the respective operating voltages.

In a preferred form, the device includes more than two energy storage cells.

According to a twenty first aspect of the invention there is provided an energy storage device having at a plurality of energy storage cells that each include two terminals, adjacent terminals being engaged at junctions to connect the cells in series and the device including:

a first contact that is connected to one of the terminal of a first of the cells in the series;

a second contact that is connected to one of the terminals of a last of the cells in the series;

at least one intermediate contact that is connected to the respective junctions; and

resistive paths that extend between the contacts for collectively defining a resistive balance for the device.

Preferably, at least one of the resistive paths includes conductive portions and resistive portions. More preferably, the resistive portions include a resistor, Even more preferably, the resistive portions comprise a resistor. In other embodiments, the resistive portions include one or more active components. In further embodiments, the resistive portions include a combination of one or more active components and one or more passive components. Preferably, the active components include one or more of: an operational amplifier; a diode; a transistor, and another active device. Preferably, the passive components includes one or more of: a resistor; a capacitor; and another passive device.

### BRIEF DESCRIPTION OF THE DRAWINGS

Preferred embodiments of the invention will now be described, by way of example only, with reference to the accompanying appendix and drawings in which:

Appendix 1 characterises a set of example supercapacitors suitable for use in the embodiments of the invention;

FIG. 1 is a histogram of leakage current of 1956 individual cells used in the dual cell supercapacitor of Example 1, where the mean leakage current is 0.179 microamps, and the standard deviation 0.030 microamps (being 17% of the mean);

FIG. 2 is a histogram of the capacitance of the cells of FIG. 1, where the mean is 0.475 Farads and the standard deviation is 0.011 Farads (being 2.3% of the mean);

FIG. 3 is a histogram of ESR for the cells of FIG. 1, where the mean is 25.8 milliohms, and the standard deviation is 1.5 milliohms (being 5.8% of the mean);

FIG. 4 is a histogram of the leakage currents of 1354 individual cells used in the dual cell supercapacitor of Example 2, where the mean leakage current is 0.151 microamps, and the standard deviation is 0.102 microamps (being 67% of the mean);

FIG. 5 is a histogram of the capacitance of the cells of FIG. 4, with a mean of 0.557 Farads and a standard deviation of 0.015 Farads (being 2.7% of the mean);

FIG. 6 is a histogram of the ESR of the cells of FIG. 4, with a mean of 33.7 milliohms and a standard deviation of 1.9 milliohms (being 5.7% of the mean);

FIG. 7 is a graph of the charge current versus time for 10 cells typical of those used in the supercapacitor of Example 1, where the current is measured at 70° C. and 2.3 Volts;

FIG. 8 is a graph of the leakage current versus temperature for 10 cells typical of those used in the supercapacitor of Example 1, measured at a constant voltage (in this instance 2.5 Volts);

FIG. 9 is a graph of the leakage current versus voltage for 10 cells typical of those used in the supercapacitor of Example 1, measured at a constant temperature (in this instance 70° C.);

FIG. 10 is graph of the leakage current versus cell voltage for 2 unmatched cells typical of those used in the supercapacitor of Example 1, measured at a constant temperature (in this instance 70° C.);

FIG. 11 is a graph of the charge current versus time for 2 unmatched cells typical of the supercapacitor of Example 1, measured at 70° C. and 2.3 Volts for 38 hrs;

FIG. 12 is a graph of three charge/discharge cycles for eight cells typical of those used in the supercapacitor of Example 2, measured at 50° C., and charged to 1.0 Volt with a series 1 kΩ resistor, then short circuited with the 1 kΩ resistor,

FIG. 13 is a voltage distribution for a dual cell supercapacitor of Example 2 tested at an operating voltage of 4.5 Volts and a temperature of 50° C. without and with balancing resistors;

FIG. 14 is a perspective view of a resistive balance according to one aspect of the invention;

FIG. 15 is a top view of the balance of FIG. 14;

FIG. 16 is a bottom view of the balance of FIG. 14;

FIG. 17 is a perspective view of a partially assembled supercapacitor that includes the balance of FIG. 14;

FIG. 18 is a perspective view of a fully assembled supercapacitor that includes the balance of FIG. 14;

FIG. 19 is a circuit diagram of for the supercapacitor of FIG. 18;

FIG. 20 is a schematic representation of a PC card to which the resistive balance of FIG. 14 is mounted;

FIG. 21 is a top view of an alternative supercapacitor including a resistive balance in accordance with another embodiment of the invention;

FIG. 22 is a side view of the supercapacitor of FIG. 21;

FIG. 23 is a top view of one of the cells included within the supercapacitor of FIG. 21;

FIG. 24 is a top view of the other of the cells included within the supercapacitor of FIG. 21;

FIG. 25 is a top view of the cells of FIGS. 23 and 24 at an intermediate stage of assembly of the supercapacitor of FIG. 21;

FIG. 26 is a side view of the cells of FIG. 25;

FIG. 27 is a side view of a resistive strip that is included within the supercapacitor of FIG. 21;

FIG. 28 is a top view of the strip of FIG. 27;

FIG. 29 is a bottom view the strip of FIG. 27;

FIG. 30 is a plan view of an alternative resistive strip to that illustrated in FIG. 27;

FIG. 31 is a side view of the strip of FIG. 30;

FIG. 32 is a plan view of a plurality of the strips of FIG. 30 during their formation;

FIG. 33 is a plan view of an alternative resistive strip to that shown in FIG. 30;

FIG. 34 is a plan view of a further alternative resistive strip to that illustrated in FIG. 27;

FIG. 35 is a plan view of a plurality of the strips of FIG. 34 during their formation;

FIG. 36 is a block diagram of an electrical device including a balance according to an embodiment of the invention;

FIG. 37 is a circuit diagram of the balance shown in FIG. 23;

FIG. 38 is a circuit diagram of an alternative embodiment of a balance of the invention, including high impedance balancing resistors;

FIG. 39 is a circuit diagram of a further alternative embodiment of the invention;

FIG. 40 is a circuit diagram of a further embodiment of the invention that is similar to the FIG. 26 embodiment, although including balancing resistors;

FIG. 41 is a circuit diagram of another embodiment of the invention for protecting and balancing more than two capacitors and which includes a pseudo-cascaded combination of two of the devices of FIG. 26;

FIG. 42 is a circuit diagram of a further embodiment of the invention;

FIG. 43 is a circuit diagram of another embodiment of the invention similar to FIG. 29 and including balancing resistors;

FIG. 44 is a circuit diagram of an alternative balance according to the invention;

FIG. 45 is a detailed view of one of the sub-devices of the balance of FIG. 31;

FIG. 46 is a circuit diagram of a device that is similar to that of FIG. 31, although including a balancing resistor;

FIGS. 47(a) to (f) are circuit diagrams of further embodiments of active balances according to the invention and which are based upon MOSFET devices; and

FIGS. 48(a) to (d) are circuit diagrams of further embodiments of active balances according to the invention and which are based upon bipolar devices.

### DESCRIPTION OF THE PREFERRED EMBODIMENTS

Energy storage cells used in supercapacitors are, like other electronic components, typically manufactured in high volumes. All high volume manufacture involves some compromises and the acceptance of tolerances in key characteristics of the devices being manufactured. This is no different for supercapacitive cells.

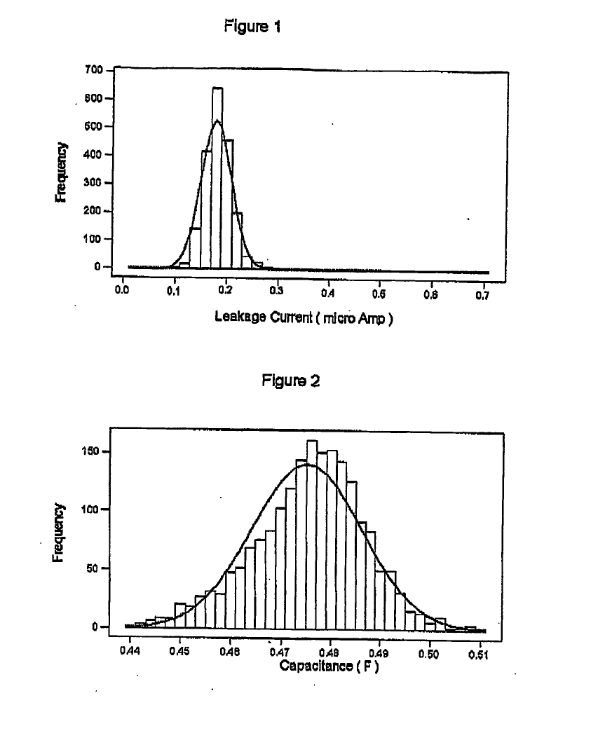

Referring to FIGS. 1 to 6, there are provided respective histograms that illustrates the distribution of various parameters of batches of mass produced notionally like cells for use in supercapacitors. It will be appreciated that while the distributions shown in the figures are typical, variations will arise between batches depending upon a variety of factors, including manufacturing vagaries and sample sizes. There will be similar distributions for other performance parameters. While some of these parameters are more economical to control within tighter tolerances than others, exact correspondence is neither expected nor achievable.

When matching calls for connection in series, one typical parameter that is often matched is leakage current (I_{L}) after a period of tens of hours. This is due to the fact that a variation in I_{L} provides a corresponding percentage variation the EPR of a cell. For example, in FIG. 1, the standard deviation is 17% of the mean, which indicates that randomly combined cells—which are combined to form the Example 1 supercapacitor in Appendix 1—will have, on average, a corresponding percentage variation in EPR. With a typical EPR being about 12 MΩ, there will be 4 MΩ difference between ±1 standard deviation. Whereas, in FIG. 4, which is data for a batch of cells—which, in use, are combined in series to form the Example 2 supercapacitor in Appendix 1—the standard deviation is 67% of the mean. Accordingly, this latter batch will yield a for greater variation in EPR.

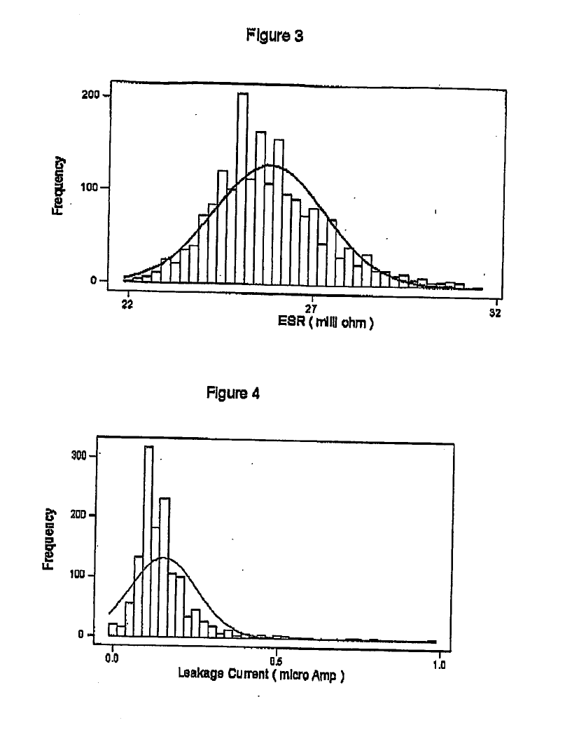

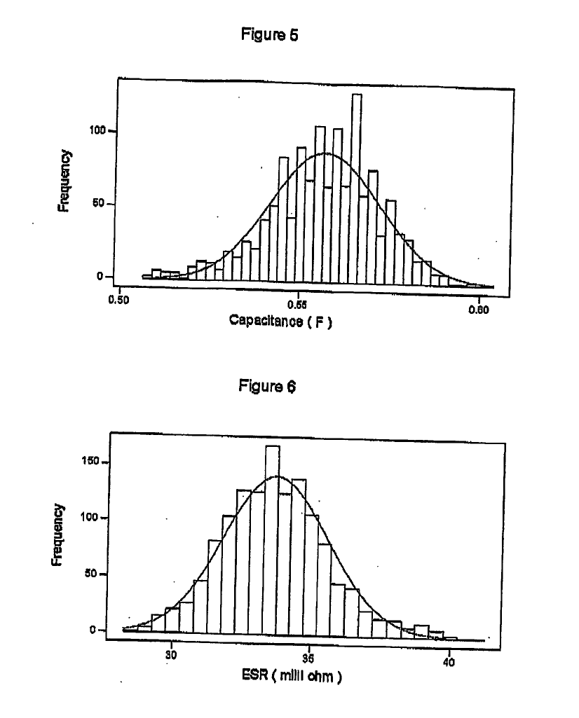

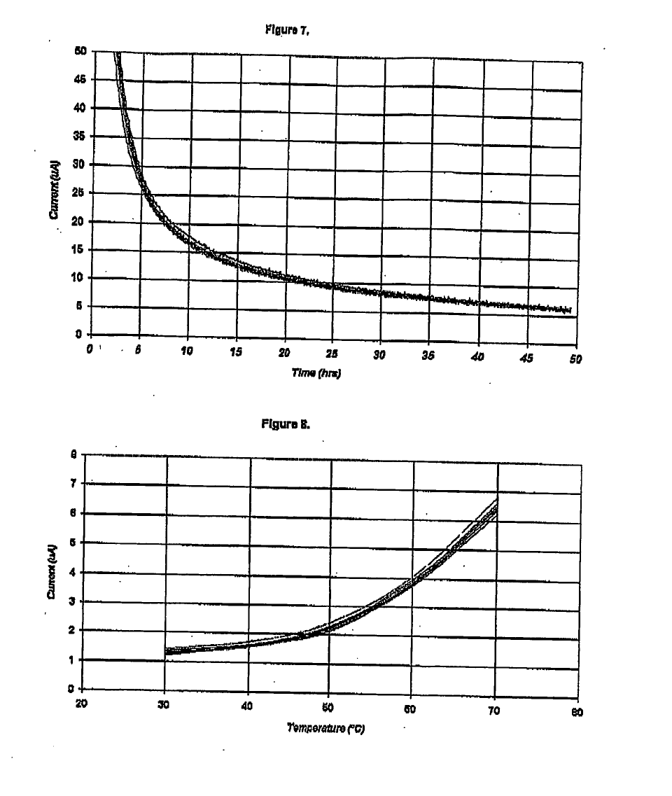

FIGS. 2 and 3 illustrate the respective capacitance and ESR distributions for the cells from which the two cells were selected for the Example 1 supercapacitor. FIGS. 5 and 6 illustrate corresponding distributions for the cells from which were selected the two cells for the Example 2 supercapacitor. Each of these Figures demonstrates the practical difficulties encountered in achieving an ideal match of identical cells.

FIG. 7 demonstrates that there normally exist differences in the charge storage currents between notionally like devices. While the general character of the currents are the same—in that they decay approximately exponentially over about forty eight hours for the specific cells concerned—the rates of the decay vary between the cells. It also demonstrates:

a) The decay of the charge storage current and transiting to a leakage current.

b) The temperature dependency of leakage current. For example, in FIG. 7 the leakage current is about 6 μA at 70° C., which is in contrast to FIG. 1 that demonstrates, for the same cells at about 23° C., the leakage current is about 0.2 μA.

FIG. 8 illustrates the temperature dependency of leakage current, and also that that temperature dependency varies between notionally like cells. That is, there is a spread of leakage currents for the ten cells at all the temperatures illustrated in the Figure. Additionally, the spread tends to increase with temperature.

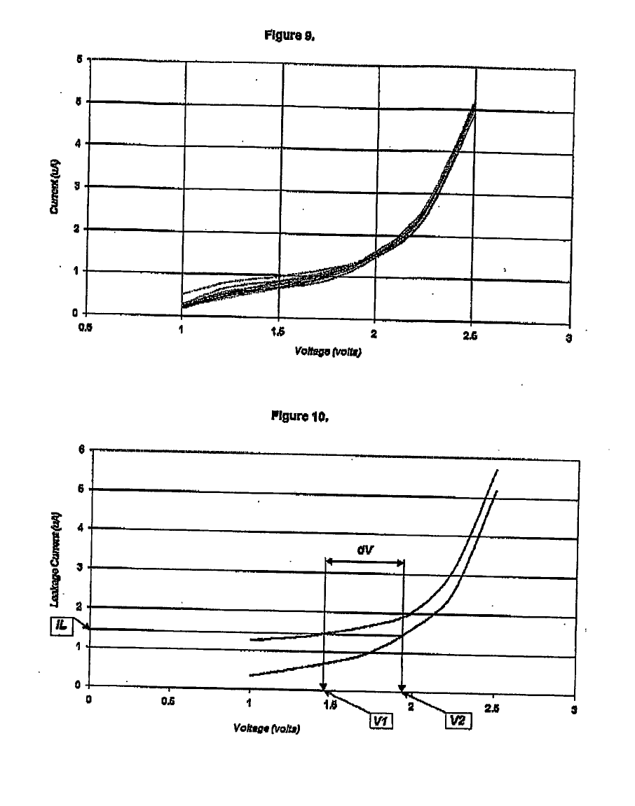

FIG. 9 illustrates the voltage dependency of leakage current, and also that that voltage dependency varies between notionally like cells. It will be appreciated that the voltage being measured is the cell voltage. There is a spread of leakage currents for the ten cells at all the cell voltages illustrated in the Figure.

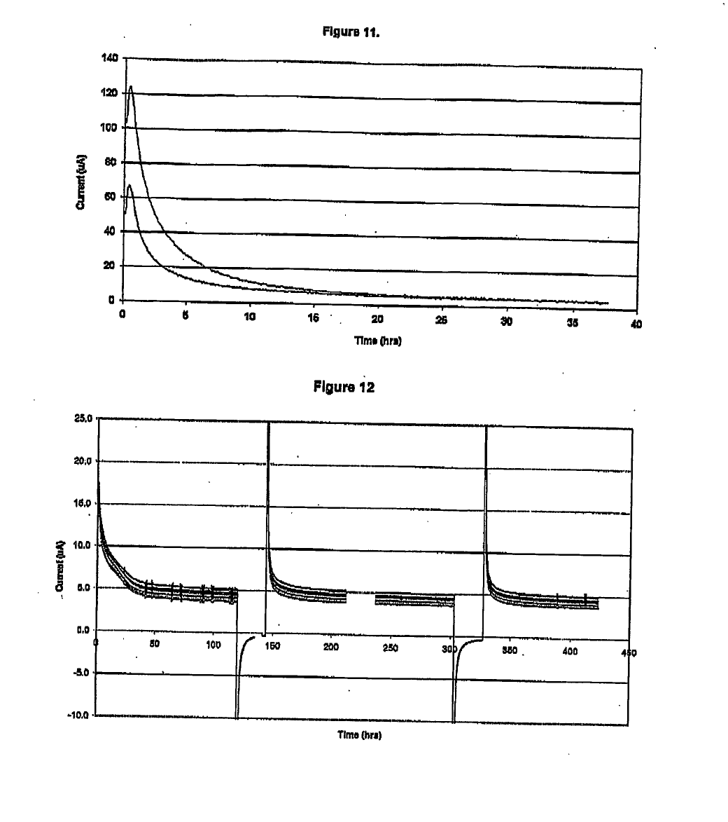

FIG. 10 is similar to FIG. 9, but taking two specific cells to illustrate the leakage current differential, and the corresponding cell voltage differential for those cells at 70° C. If these two cells were paired in series, a leakage current would generate different cell voltages demonstrating imbalance between the cells.

FIG. 11 relates to two cells that are selected for small differences in leakage current at 23° C. When the temperature of those cells is increased to 70° C., the charge currents are considerably different, notwithstanding that the leakage currents are similar. If the cells were series connected, this differential would give rise to considerable voltage imbalance between the cells. That is, matching cells for certain environmental conditions does not ensure the cells will be matched for variations in those conditions.

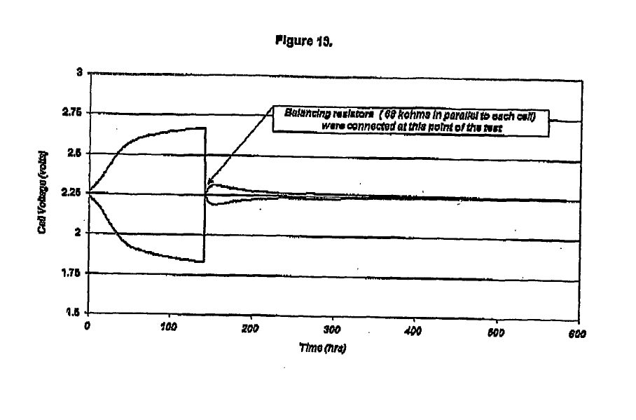

FIG. 12 relates to charging and discharging notionally similar cells at a constant temperature. This demonstrates the differences in leakage currents and charging currents between the cells when the cell voltage is switched on and off. Accordingly, there is also a difficulty in achieving voltage balance between series connected cells if the voltage across the series is switched on and off.

FIG. 13 is of two matched cells from Example 2 that are connected in series. For the first 150 hours the cells were without balancing, and as such, the individual cell voltages diverged. However, after 150 hours, the cells were balanced with a purely restive balance according to the invention, and the individual cell voltages converged due to the bias provided by the balancing. As the cells are like cells, the balance biased the voltages toward equality.

The embodiments of the invention are suitable for use with a wide variety of supercapacitors and supercapacitive cells, some of which are exemplified in Appendix 1. However, the embodiments are not limited for use with those examples, and are also suitable for use with other supercapacitors and cells. By way of illustration, the embodiments of the invention are also suitable for use with the cells and supercapacitors of the types included in the earlier PCT patent applications PCT/AU99/0181, PCT/AU01/00838, PCT/AU01/0163, PCT/AU01/01590, PCT/AU02/01766, and PCT/AU03/00334, the disclosure of which is included herein by way of cross reference.

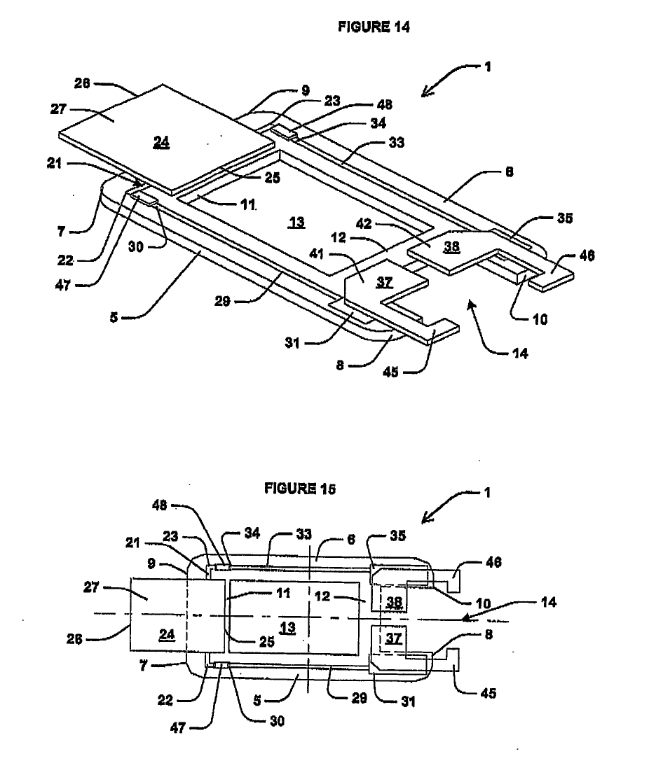

Referring to FIGS. 14 to 16 there is illustrated a resistive balance 1 for an energy storage device in the form of a supercapacitor 2. The supercapacitor is beat shown in FIG. 18 and has two energy storage cells 3 and 4. The balance is disposed intermediate the cells.

Balance 1 includes two parallel, spaced apart and co-extensive longitudinal members 5 and 6 that respectively extend between ends 7 and 8 and ends 9 and 10. Two parallel, spaced apart and co-extensive transverse members 11 and 12 extend between members 5 and 6. While member 11 is attached to members 7 and 9 immediately adjacent to ends 7 and 9 respectively, member 12 is attached to members 7 and 8 adjacent to but spaced inwardly from respective ends 8 and 10.

All the members are integrally formed from a single piece of circuit board that is punched or otherwise formed to the required shape. In this embodiment, the members collectively define a central aperture 13, while members 5, 6 and 12 collectively define an end notch 14.

A continuous conductive metal track 21 is formed on members 5, 6 and 11 and extends transversely between ends 22 and 23. An electrically conductive generally square metal tab 24 is fixedly mounted to member 11 and overlies and intimately electrically contacts track 21. Tab 24 extends transversely across all of member 11, and longitudinally between a first end 25 and a second end 26 that lies longitudinally outwardly of member 11 and ends 7 and 9. Tab 24 includes an upper face 27 and a lower face 28.

Tab 24 is connected to member 11 by a conductive adhesive (not shown). In other embodiments, however, alternative means of connection include soldering or heat or other welding.

Ends 22 and 23 of track 21 include longitudinal portions, as best shown in FIG. 15, that extend toward ends 8 and 10 respectively.

Another conductive metal track 29 extends longitudinally along member 5 between an end 30 and a generally square metal contact patch 31. End 30 is adjacent to but spaced apart from end 22 of track 21. Similarly, a conductive metal track 33 extends longitudinally along member 6 between an end 34 and a generally square metal contact patch 35. End 34 is adjacent to but spaced apart from end 23 of track 21.

Two metal tabs 37 and 38 are formed from copper sheet and overlap and are intimately electrically contacted with respective patches 31 and 35.

These tabs 37 and 38 each include respective fixed portions 41 and 42 that have upper and lower faces, where the lower faces of the tabs overlap and are abutted with patches 31 and 35. The tabs also include free portions 45 and 46 that extend longitudinally beyond ends 8 and 10 of members 5 and 6. In other embodiments, portions 45 and 46 extend transversely beyond members 5 and 6 respectively. In further embodiments, portions 45 and 46 extend both transversely and longitudinally beyond members 5 and 6.

Balance 1 includes two surface mount resistors 41 and 48. Resistor 47 bridges the gap between end 30 of track 29 and end 22 of track 21 for providing a resistive path between tab 24 and tab 37. That path successively includes tab 24, track 21, resistor 47, track 29, patch 31 and tab 37. Similarly, resistor 48 bridges the gap between end 34 of track 33 and end 23 of track 21 for providing a resistive path between tab 24 and tab 38. That path successively includes tab 24, track 21, resistor 48, track 33, patch 35 and tab 38. It will be appreciated that substantially all the resistance between tab 24 and tabs 37 and 38 is provided by resistors 47 and 48.

In other embodiments alternative resistive devices are used, one of which is described in more detail below such as standard carbon based resistors or polymer resistors.

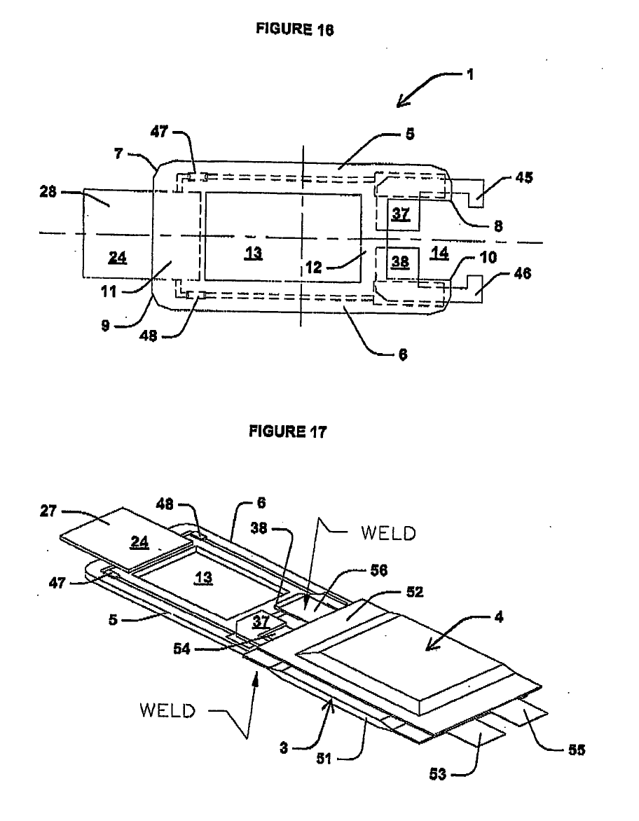

As best shown in FIG. 17, cells 3 and 4 respectively include sealed laminar housings 51 and 52. Although not shown, within each of housing there is disposed a plurality of opposed electrodes, an insulating separator for maintaining the electrodes in a fixed spaced apart configuration, and an electrolyte for allowing ionic conduction between the electrodes. In this embodiment each housing contains a plurality of pairs of stacked electrodes. However, many other configurations are possible, including folded or rolled electrodes. Examples of these configurations are provided in the PCT application having the publication number WO 02/47097, the content of which is incorporated herein by way of cross-reference.

Each of the electrodes within housing 51 is connected to one of two terminals 53 and 54. These terminals extend from the longitudinally from the housing, although in the opposite direction to each other, for allowing external electrical interaction with the electrodes. Similarly, each of the electrodes within housing 52 is connected to one of two terminals 55 and 56. These terminals extend from the longitudinally from the housing, although in the opposite direction to each other, for allowing external electrical interaction with the electrodes.

The mounting of cells 3 and 4 to balance 1 occurs by orientating the cells with respect to the cradle as shown in FIG. 17. This includes having terminal 54 underlie and abut the lower face of tab 37, and having terminal 56 overlie and abut the upper face of tab 38. Welds are then applied to the pairs of abutted components, as indicated schematically in the FIG., to affect two fixed electrical connections.

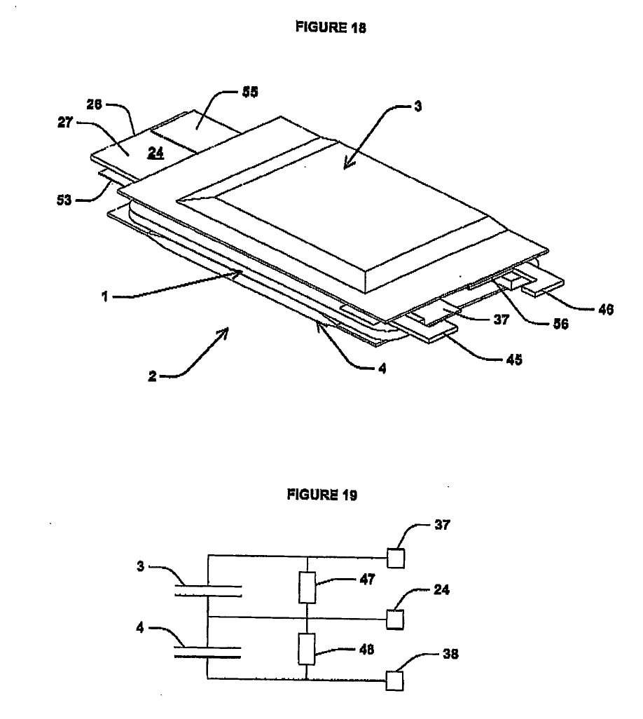

Cells 3 and 4 are then folding away from each other and about cradle 2 to assume the orientation shown in FIG. 18. As illustrated in that Figure, terminal 53 abuts the lower face 28 of tab 24, while terminal 55 abuts the upper face 27 of tab 24. These abutting components are then welded to each other to effectively electrically connect terminals 53 and 55 and tab 24. A circuit diagram for supercapacitor 2 is schematically illustrated in FIG. 19. That is, cells 3 and 4 are connected in series with each other, and in parallel with respective resistors 47 and 48.

It will be appreciated by those skilled in the art that resistors 47 and 48 are selected to provide substantially the same resistance. Accordingly, both cells 3 and 4 are maintained at about the same voltage by the resistive voltage divider formed by resistors 47 and 48. This ensures that, during use, the risk of over voltage on one of the serially connected cells is substantially reduced.

Cells 3 and 4 are thinner about their respective peripheries than at their centres due to the electrodes within those cells being centrally disposed within housings 51 and 52. Accordingly, when those cells are folded about balance 1, the opposed housings extend into aperture 13 and abut or are closely adjacent. In this way members 5, 6, 11 and 12 are further captively retained in engagement with cells 3 and 4. Moreover, due to this interaction, balance 1 contributes very little to the overall thickness of supercapacitor 2.

As shown in FIG. 18, tab 24 and portions 45 and 46 extend longitudinally beyond balance 1 and housings 51 and 52 and are accessible for electrical connection to other circuitry or components. In this embodiment portions 45 and 46 are electrically connected to a circuit board (not shown) by soldering, while tab 24 is left as is. In other embodiments, however, tab 24 is connected also to the relevant circuit board or other electrical components to allow the voltage at that tab to be accessed and/or controlled.

The embodiment illustrated in the drawings FIGS. 14 to 19 provides a convenient and cost effective means for enabling a resistive balance for a supercapacitor. That is, supercapacitor 2 is able to be retrospectively fitted to an existing circuit board and gain the resistive balance functionality. For example, supercapacitor 2, in some embodiments, replaces a capacitor and, for the same volume, offers a far greater capacitance. In other embodiments, supercapacitor 2 replaces an unbalanced supercapacitor and is thereby able to offer improved stability and lifetime while occupying substantially the same volume.

As cells 3 and 4 are stacked one on the other they occupy less area of the board to which they are mounted and thereby provide greater design flexibility. Additionally, tab 24 is available to be accessed, as required.

In the above embodiments, resistors 47 and 48 are surface mount resistors having a resistance of 150 kΩ at a tolerance of ±1%. It will be appreciated that the resistances are chosen based upon the EPRs of the cells in series operational voltages experienced and are matched to provide the desired degree of sensitivity required from the balance. In other embodiments different resistances, types of resistors and tolerances are used

In the FIG. 14 embodiment, each of cells is about 27 mm long, about 17 mm wide, and about 1 mm tick. The total thickness of supercapacitor 2 is about 2.1 mm, which is only marginally thicker than the combined thickness of cells 3 and 4.

Reference is now made to FIG. 20 where there is illustrated a communications card 61 for a wireless computer network (not shown) that includes a supercapacitive device (not explicitly shown) having a balance according to FIG. 14. In other embodiments, the communications card is a class 10 or class 12 GRPS card, while in further embodiments it is a PCMCIA card. It will be appreciated by those skilled in the art that many other communications cards, and other cards, are also used in other embodiments.

Card 61 includes a standardised PCB 62 to which are mounted many components for providing the functionality required from the card. The card is intended for insertion into a slot of an electronic device and, in his case, like cards 61 are included within a plurality of electronic devices such as a desktop computer 63, a laptop computer 64 and a printer 65. Once so included, and configured with the required drivers, they allow for wireless network communications between the electronic devices.

Other cards that include balance 1 are of different dimensions and provide different functionalities. Those additional cards are also intended for use with other electronic devices such as still and video cameras, PDA's, cellular telephones, modems, servers and the like. Moreover, in some oases, cradle 1 is not mounted to a card but, instead, directly to a motherboard or other circuit board of the electronic device.

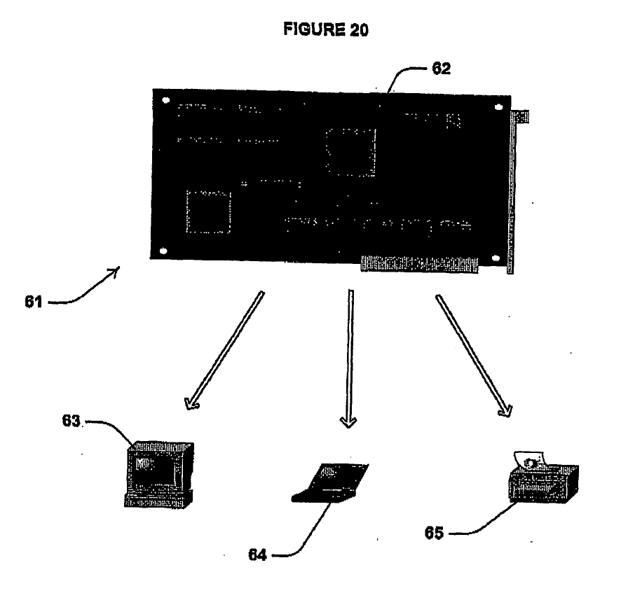

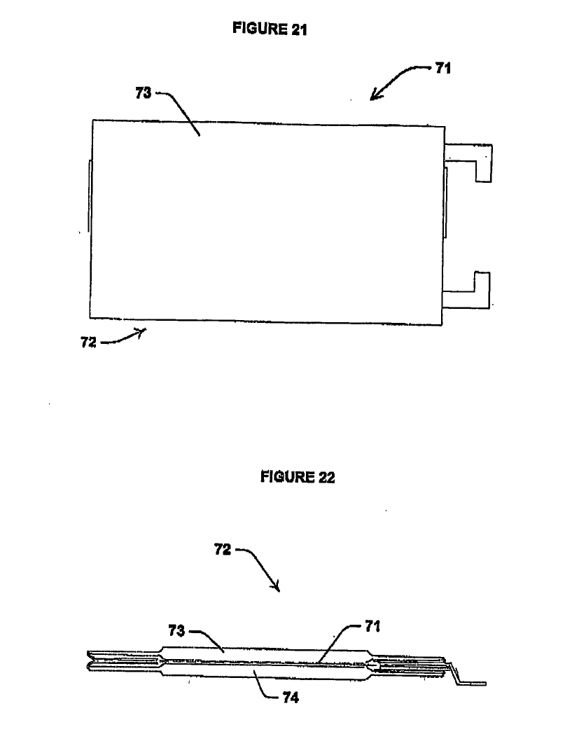

Reference is now made to FIGS. 21 to 26 where there is illustrated an alternative resistive balance 71 that is depicted as a broken line in FIG. 22. Balance 71 is for an energy storage device in the form of a supercapacitor 72 that has two energy storage cells 73 and 74. Balance 71 is disposed wholly intermediate the cells. In other embodiment, the balance is substantively disposed between the cells,

Various embodiments of supercapacitor 72 are provided in examples 1 to 30 from Appendix 1.

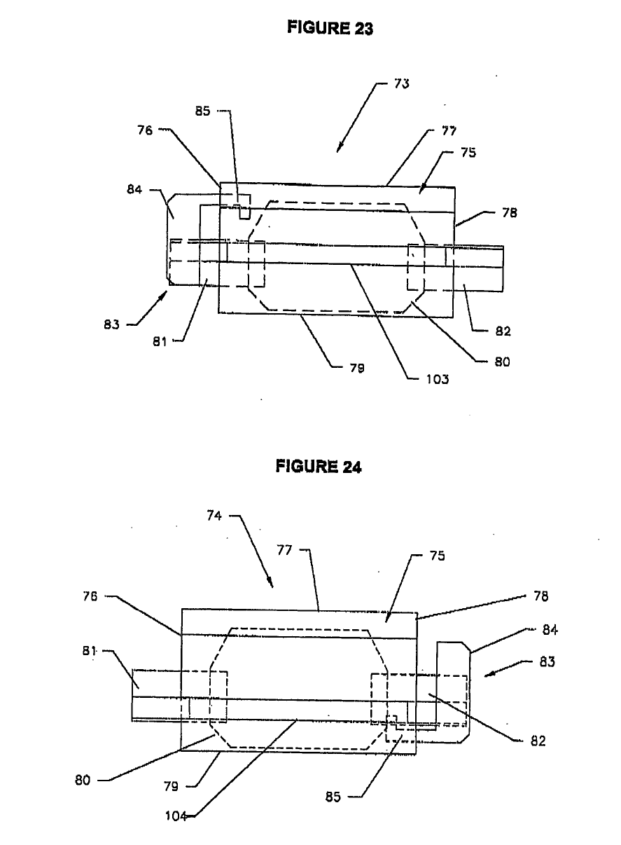

As shown in FIG. 23, cell 73 includes a generally rectangular laminar housing 75 having edges 76, 77, 78 and 79. Housing 75 is formed from a single laminar sheet that is first folded in half about an energy storage element 80, which is depicted in the FIG. by broken lines. It will be appreciated that the fold defines edge 79. Housing 75 is then heat welded along edges 76 and 78 to define a pocket having an upwardly facing opening (not shown). A liquid electrolyte is inserted into the opening of the pocket, while gases and other contaminants such as water are removed. Housing 75 is heat welded about the opening to sealingly retain element 80 and the electrolyte within housing 75. A portion of the heat sealed housing is then folded back across itself to define edge 77.

Element 80 includes a plurality of opposed and stacked electrodes and intermediate insulating separators for maintaining those electrodes in a spaced apart configuration. One half of the electrodes in the stack are electrically connected to a generally rectangular aluminium tab 81 to collectively form a first set of electrodes, while the other half of the electrodes are electrically connected to a generally rectangular aluminium tab 82 to collectively form a second set of electrodes, The electrodes in the first set are interleaved with the electrodes in the second set to provide a maximum opposed electrode geometric area. Moreover, the electrodes ate coated with high surface area material such as activated carbon to optimise the opposed surface area between the electrodes.

Tabs 81 and 82 extend from within housing 75 in opposite directions and are respectively captively and sealingly retained by the heat welded edges 76 and 78. The tabs allow external electrical connection to element 80 and their primary properties are conductivity, strength and suitability for connection to other components.

A punched copper teal 83 includes a body 84 that is electrically connected at one end to the free end of tab 81. In this embodiment the connection is affected by welding. However, in other embodiments, use is made of soldering or a conductive adhesive. A terminal leg 85 extends normally from the other end of body 84 and has a free end that is intended for engagement with a circuit board (not shown).

The EPR of cell 73, measured between tabs 81 and 82, is about 1.5 MΩ. It will be appreciated by those skilled in the art that manufacturing and material tolerances give rise to variations of EPR between like cells.

A flat resistive strip 103 is electrically connected to tabs 81 and 82 to define a resistive path between the tabs having a predetermined resistance. In this embodiment, the predetermined resistance is about 150 kΩ. This strip will be described in more detail below.

Cell 74 is similar to cell 73 and is shown in FIG. 24, where corresponding features are denoted by corresponding reference numerals. In the case of cell 74, terminal 83 is connected to tab 82. Moreover, the connection with the tab is adjacent to the end of body 84 from which leg 85 extends. The reason for this will become clear tom the following description.

The EPR of cell 74, measured between tabs 81 and 82, is about 1.5 MΩ. While this is similar to the EPR of cell 73, it will be appreciated by those skilled in the art that manufacturing and material tolerances give rise to variations of EPR between the cells. In some assembly processes the cells are matched. Notwithstanding, it is not unusual to see a 10% variation in EPR between nominally like cells.

A flat resistive strip 104 is electrically connected to tabs 81 and 82 of cell 74 to define a resistive path between the tabs having a predetermined resistance. In this embodiment, the predetermined resistance is about 150 kΩ, which is that same as the predetermined resistance provided by strip 103.

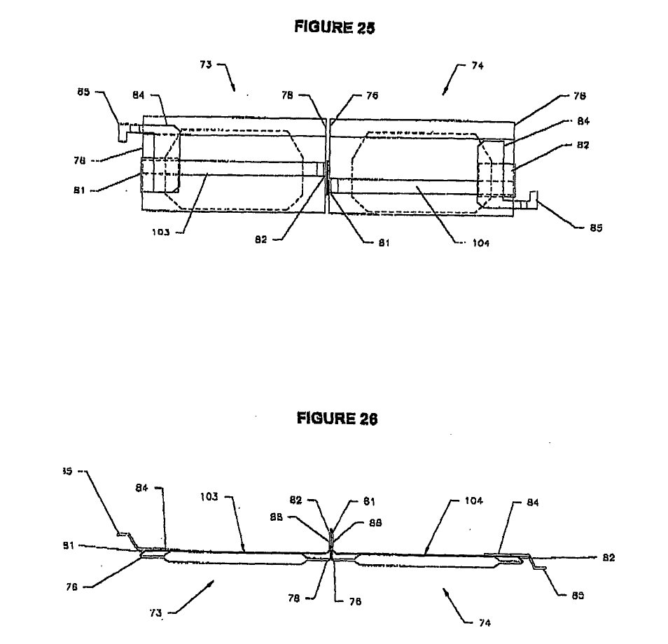

The next step of assembling balance 71 is best shown in FIG. 25 and FIG. 26, where cells 73 and 74 are placed side-by-side.

Tab 82 of cell 73 and tab 81 of cell 74 are folded at edges 78 and 76 respectively to co-extend normally upwardly from the calls. Those tabs are abutted with each other and ultrasonically welded together. In other embodiments alternative methods of connection are used, such as soldering.

Tab 81 of cell 73 is folded about edge 76 by 180° such that body 84 of terminal 83 overlies cell 73, and that leg 85 of terminal 83 extends longitudinally outwardly beyond cell 73. Similarly, tab 82 of cell 74 is folded about edge 78 by 180° such that body 84 of terminal 83 overlies cell 74, and that leg 85 of terminal 83 extends longitudinally outwardly beyond cell 74. As best shown in FIG. 26, the terminal 83 that is attached to cell 74 includes a leg 85 that extends downwardly as well as outwardly, while the terminal 83 that is attached to cell 73 extends upwardle as well as outwardly. Importantly also, and as best shown in FIG. 25, the legs are transversely offset.

The connection of tab 82 of call 73 to tab 81 of cell 74 has the effect of connecting those cells serially. In this embodiment, terminal 83 of cell 73 defines a positive terminal of supercapacitor 72, while terminal 83 of cell 74 defines a negative terminal of supercapacitor 72.

Cells 73 and 74 are then folded 180° about connected tabs 81 and 82 so as to overlie each other. That is, cells 73 and 74 are progressed from the configuration shown in FIGS. 25 and 26 to the configuration shown in FIG. 21 and FIG. 22.

In other embodiments, cells 73 and 74 are left in the flat configuration shown in FIGS. 25 and 26. Embodiments of such supercapacitors are provided in examples 31 to 44 from Appendix 1.

In some embodiments cells 73 and 74 include an intermediate sheet of double sided adhesive (not shown) to retain the cells in the folded configuration of FIGS. 21 and 22. This adhesive also insulates the positive terminal from the negative terminal. In other embodiments, however, a single sided adhesive strip is wrapped about the folded cells. In still further embodiments no adhesive is used but, rather, reliance is placed upon the soldering of legs 85 to a circuit board or other substrate.

In embodiments where a double sided adhesive is not used between cells 73 and 74, some other insulating material is disposed between the two adjacent terminals 83 to prevent a short-circuit between these elements.

Balance 71 extends longitudinally between an end 87 and an end 88 and overlies substantially all of cell 74. End 87 overlies body 84 of terminal 83, while end 88 terminates adjacent to the connected tabs 81 and 82.

Cell 73 is then folded about its edge 78—which is effectively joined to edge 76 of cell 74—by 180° and into the configuration shown in FIGS. 21 and 22. This results in the combined tabs 81 and 82 being brought into engagement with end 88 of balance 71, and end 87 being engaged on opposite sides by the bodies 84 of terminals 83.

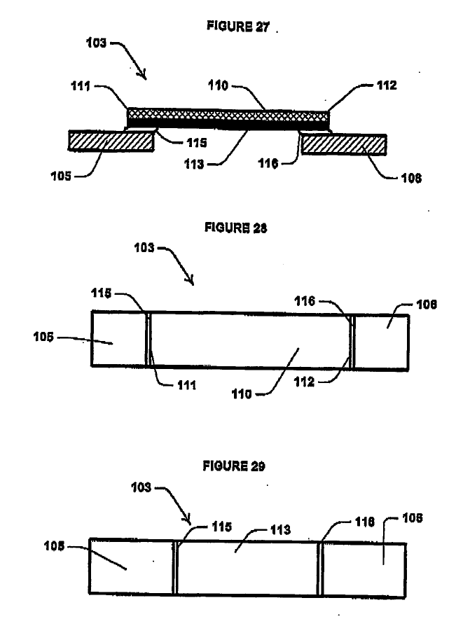

Resistive strips 103 and 104 will now be described in more detail with reference to FIGS. 27, 28 and 29. While, for the purposes of clarity, only strip 103 is shown, it will be appreciated that strip 104 is similar

Strip 103 includes two spaced apart aluminium termination tabs 105 and 106. An insulating Teflon® substrate 110 has an end 111 that overlaps with and which is adjacent to tab 105. Substrate 110 extends longitudinally from end 111 to an end 112 that overlaps with and which is adjacent to tab 106. A resistive polymer layer 113 is formed on the entirety of the underside of substrate 110 and is electrically connected with tabs 105 aid 106 by respective conductive adhesive contacts 115 and 116.

The resistive strips are formed by laying down on a metallic surface a 25 micron thick Teflon® layer having an area of about 10,000 mm². This layer is the precursor to substrate 110. A 50 micron thick layer of polymer—such as that sold by Metech, Inc and designated as the “8600 Series”—is then evenly applied across the Teflon® layer and allowed to cure to form layer 113, Two spaced apart parallel strips of liquid adhesive contacts are then applied to layer 113, and respective 0.1 mm thick aluminium strips are then placed brought into engagement with the adhesive contacts. The contacts are then also allowed to cure.

Once that has occurred, the composite laminate material is cut into strips that are about 3 mm wide and 23 mm long to form a plurality of resistors 103 and 104. It will be appreciated that by varying the length, the thickness and the width of the resistive material, that different values of resistance are obtainable. In this embodiment, the 3 mm×23 mm×50 microns resistor 103 provides a resistance of about 150 kΩ.

The resistive and structural properties of strip 103 are provided almost entirely by layer 113. The role of substrate 110 is as an insulator that facilitates the manufacturing steps and which protects layer 113 from inadvertent electrical contact during use. The adhesive contacts are the precursor to the individual contacts 115 and 116, while the aluminium strips are the precursor to tabs 105 and 106.

Adhesive contacts 115 and 116 are, in this embodiment, formed from a two-part conductive flexible epoxy adhesive. For example, use is made of Resinlab™ SEC 1233 or similar products.

The use of such resistive ships and adhesive allows for considerable flexibility in design and manufacture. In applications where a higher parallel resistance is required—for example where lower leakage currents are experienced—then strips 103 and 104 are simply made less thick and/or longer and/or less wide, Conversely, where a lower resistance is adequate, strips 115 and 116 are made thicker and/or shorter and/or less wide.

The major advantages of strips 103 and 104 are:
1. A minimal thickness—in this embodiment less then 100 microns—and thereby not adding substantively to the overall thickness of supercapacitor 72. Typically, even when the cells are abutted there are one or more gaps between them.

Preferably, the resistors are placed into these to gaps and, hence, contribute even less, if at all, to the overall thickness of the supercapacitor.
2. They are simple and cost effective to manufacture and include within an automated manufacturing process for the supercapacitor.
3. Robust and thereby easy to handle in a production environment.

Reference is now made to FIGS. 31 and 31 where there is illustrated an alternative resistive strip 117. This strip includes a 0.1 mm thick flexible circuit board 118 that extends between a first end 119 and a second end 120. In this embodiment, the distance between ends 119 and 120 is about 27.5 mm, while the width of board 118 is about 2.75 mm. However, in other embodiments alternative distances and widths are used.

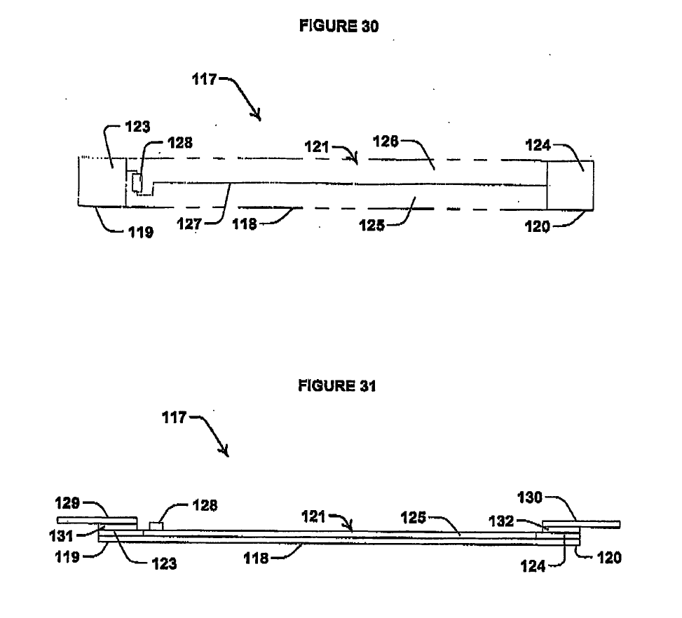

Strip 117 includes a copper layer 121 that is deposited on board 118. Layer 121 is selectively chemically etched to provide, as best shown in FIG. 30, two generally square end portions 123 and 124, and two elongate mid portions 125 and 126. Portions 125 and 126 are electrically isolated from each other by an arrow dividing strip 127 that is constituted by an absence of copper. Moreover, portion 123 and 125 are electrically connected to each other, and portions 124 and 126 are electrically connected to each other.

Also included is a 150 kΩ surface mount resistor 128 that bridges between portions 125 and 126. The end result being that a resistance of about 150 kΩ is provided between portions 123 and 124, as portions 125 and 126 have a very low resistance. Resistor 128 is soldered into fixed electrical engagement with portions 125 and 126. In other embodiments, however, use is made of alternative means of engagement, including electrically conductive adhesives.

As shown in FIG. 31, strip 117 also includes two 0.1 mm thick aluminium tabs 129 and 130 that are attached to respective portions 123 and 124 by conductive adhesive 131 and 132. Tabs 129 and 130 extend outwardly and away from each other to facilitate the connection of strip 117 to the cell of an energy storage device. As with the embodiments referred to above, the connection is generally by soldering, ultrasonic welding or conductive adhesive.

It will be appreciated that tabs 129 and 130 have been omitted from FIG. 30.

Strip 117 is flexible, resilient and robust. Accordingly, it is easy integrated into automated manufacture of energy storage devices.

Strip 117 is used as a substitute for resistors 103 and 104 of the embodiment referred to above.

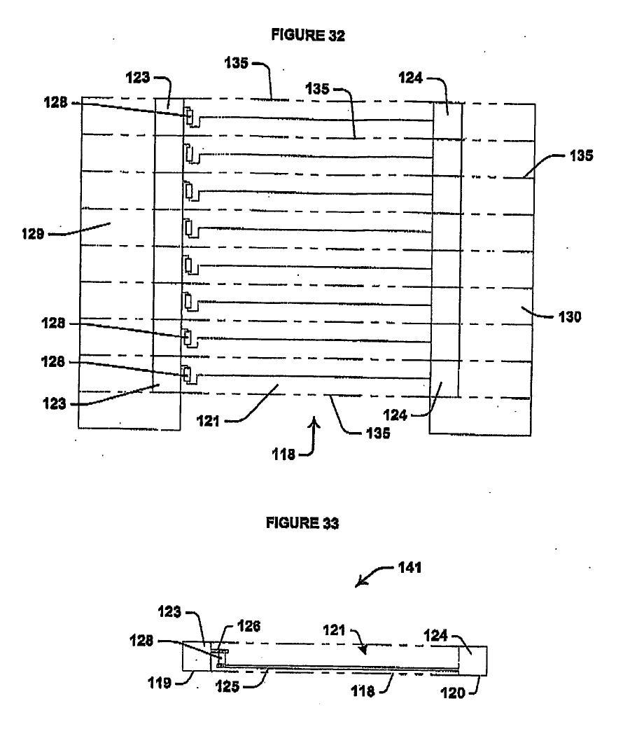

The steps of manufacturing strip 117 will now be described with reference to FIG. 32, where corresponding features are denoted by corresponding reference numerals. Particularly, the sequential steps include:
1. Depositing the thin copper layer 121 on the flexible circuit board 118.
2. Chemically etching the copper layer 121 to form a repeating array that is the basis of a plurality of strips 117.
3. Soldering a plurality of surface mount resistors 128 to interconnect the appropriate adjacent copper portions.
4. Coating the two end portions 123 and 124 of the copper with conductive adhesive.
5. Overlying two aluminium tabs 129 and 130 on the respective coats of adhesive.
6. Allowing the adhesive to cure.
7. Cutting the intermediate product along equally spaced apart parallel cut lines 135 (shown as broken lines) to form a plurality of like strips 117.

The resistance between tabs 129 and 130 is measured and matched pairs are formed for use with two cell energy storage devices.

Typically, in this embodiment, strips 117 are applied to supercapacitive cells having an EPR of about 1.5 MΩ. Accordingly, a resistance of about 150 kΩ is suitable for providing the resistive balance affect that is being sought. While in other embodiments, particularly where lower leakage currents are required, strip 117 is designed to provide greater resistance, there is a practical limit as would be appreciated by those skilled in the art.

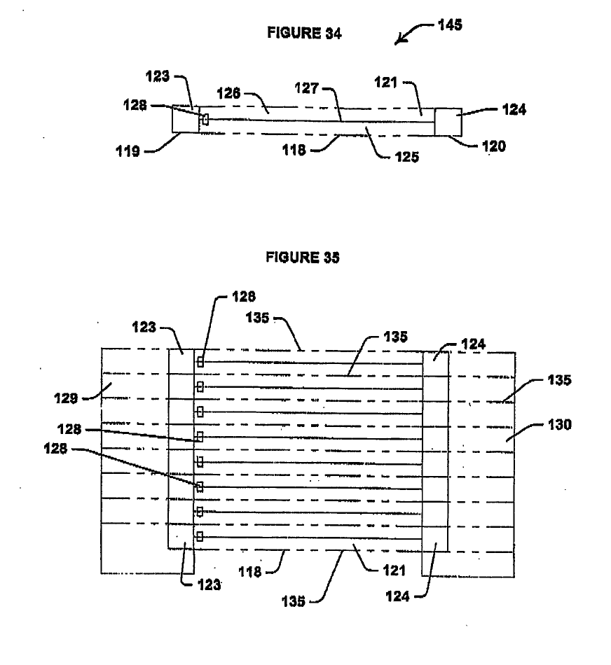

Reference is now made to FIG. 33 whom there is illustrated an alternative flexible resistive strip 141. This strip is similar to strip 117, and corresponding features are denoted by corresponding reference numerals. In this embodiment, intermediate portions 125 and 126 are in the form of parallel and offset elongate narrow conductive tracks that extend from respective portions 123 and 124 and which terminate at opposite ends of resistor 128. As the resistance of portions 125 and 126 is minimal, the total resistance between portions 125 and 126 is substantially equal to the resistance of resistor 128. While in this embodiment the resistance of resistor 128 is about 150 kΩ, in other embodiments alternative values are used.

Reference is now made to FIG. 34 where there is illustrated an alternative resistive strip 145 that has corresponding features denoted by corresponding reference numerals. In this embodiment, strip 127 is straight and portions 125 and 126 are of equal area when viewed from above. While resistor 128 is disposed at or adjacent to portion 123. In other embodiments it is disposed closer to portion 124. In this regard, strip 145 is very tolerant of any longitudinal positioning errors for resistor 128.

FIG. 35 is a view similar to FIG. 32, although for a plurality of strips 145. Other than the etching step to form skip 127, the process of manufacture of strip 145 is the same as for strip 117.

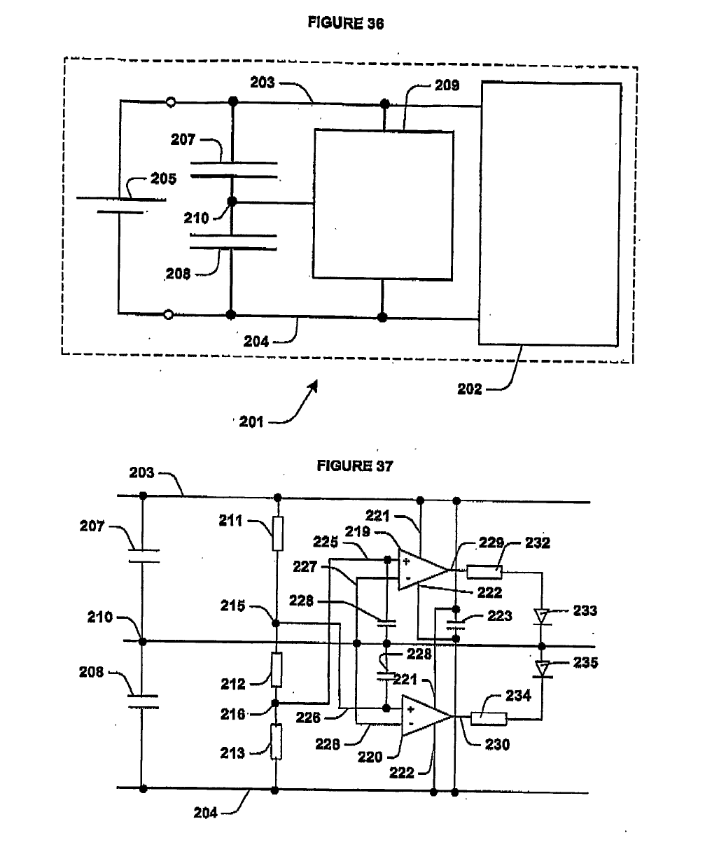

Referring to FIG. 36 there is illustrated a further embodiment of the invention. This includes an electrical device in the form of a long life toll way transponder 201 that is intended for mounting to a vehicle. The transponder includes electronic circuitry 202 for providing a predetermined functionality which, in this embodiment, is to detect an interrogation signal that is provided at a road toll station (not shown), and in response to wirelessly transmit an identifier that is unique to transponder 201. This functionality will be described further below. A pair of supply rails 203 and 204 provide electrical power to circuitry 202, while an energy storage device, in the form of a battery 205, energises the supply rails. Two series connected capacitors, in the form of 0.95 Farad carbon double layer supercapacitors 207 and 208, are connected in parallel with rail 203. A voltage balance 209 is connected in parallel with supercapacitors 207 and 208 and has a low resistance mode for progressing the supercapacitors toward a balanced state and a high resistance mode when the capacitors are in the balanced state.

In other embodiments use is made of a bank of batteries, either in series or parallel, to provide the supply voltage to rails 203 and 204. In this embodiment, battery 205 is a Lithium primary battery that is rated at 2 Amp-hours provides a nominal zero current voltage of 3.9 Volts to 2.5 Volts over its operational lifetime. In other embodiments, use is made of alternative batteries.

Supercapacitors 207 and 208 are rated for 2.3 Volts and, as such, they are placed in series to ensure that they are notionally exposed to only half of the voltage between rails 203 and 204. In this embodiment, that results in each supercapacitor being exposed to a maximum notional voltage of 1.95 Volts. In other embodiments, different supercapacitors or capacitive devices are used,

Due to normal manufacturing tolerances and changes to a supercapacitor's characteristics over its operational lifetime, the likelihood of the EPR's of the supercapacitors being identical at any time is minimal. Accordingly, there will invariably arise some imbalance in the voltages seen by the separate supercapacitors. To counter this effect, balance 209 is connected in parallel with supercapacitors 205 and 206 and has a high power consumption mode for progressing the supercapacitors toward a balanced state and a low power consumption mode when the supercapacitors are in the balanced state.

For convenience, the electrical connection between the negative terminal of supercapacitor 207 and the positive terminal of supercapacitor 208 is referred to as junction 210.

As best shown in FIG. 37, balance 209 includes a resistive voltage divider network comprised of three series connected resistors 211, 212 and 213 that extend between rails 203 and 204. These resistors have nominal resistances of 22 MΩ, 4.99 MΩ, and 22 MΩ respectively and provide a first reference voltage at a junction 215 between resistors 211 and 212 and a second reference voltage at a junction 216 between resistors 212 and 213. Preferably, the resistors have a tolerance of less than or equal to 1%.

Balance 209 also includes two low power comparators 219 and 220 that each have positive supply rails 221 that are connected to rail 203 and negative supply rails 222 that are connected to rail 204. A 0.1 μF ceramic capacitor 223 is provided to short circuit high frequency transients.

Comparators 219 and 220 each have positive inputs 225 and 226, negative inputs 227 and 228 and outputs 229 and 230. Inputs 225 and 226 are respectively directly connected to junctions 216 and 215 to access the second and first reference voltages. Two 0.01 μF ceramic capacitors 231 extend between respective inputs 225 and 226 and junction 210 to filter high frequency transients.

Inputs 227 and 228 are jointly connected to junction 210.

Output 229 is connected to a 383Ω resistor 232 that is in turn series connected with a low leakage BAV199 type diode 233. Similarly, output 230 is connected to a 383Ω resistor 234 that is in turn series connected with a low leakage BAV199 type diode 235. As also shown, the diodes are connected, at their other ends to junction 210.

In this embodiment, comparators 219 and 220 are Maxim MAX9119 comparators that each draws approximately 410 nA at room temperature when at a supply voltage of 3.9 Volts (the maximum expected operational voltage for balance 209). For completeness, it is mentioned that:
1. The comparators each typically draw 350 nA at room temperature when operating at a supply voltage of 1.8 Volts (the minimum operating voltage for the comparators).
2. The comparators each typically draw a maximum of 1.2 μA when powered at 5 Volts.
3. The above figures are at the maximum operating temperature for device 201, which is 8° C.,

Given that comparators 219 and 220 operate at a maximum supply voltage of 3.9 Volts and at a temperature usually less than about 70° C., it has been found that the typical current drawn by each comparator is less than 500 nA and averages over the lifetime of the device to be about 410 nA. Clearly, this current will vary between different devices 201 in accordance with the respective environments to which they are exposed. Additionally, as battery 205 discharges its voltage falls, as will be appreciated by those skilled in the art.

Balance 209 maintains the voltage across supercapacitors 207 and 208 below the value at which the supercapacitors are susceptible to irreversible damage. For supercapacitors 207 and 208, that voltage is nominally 2.3 Volts. Balance 209 includes a safety margin, and maintains the maximum voltage across each supercapacitor below 2.15 Volts—based upon tie 3.9 Volt maximum that is provided by battery 205.

In other embodiments use is made of different supercapacitors having different characteristics, such as different safe maximum operational voltages, different form factors, different capacitances and others. Additionally, in some embodiments use is made of alternative capacitive devices such as electrolytic capacitors, ceramic capacitors and the like.

Balance 209 draws minimal current when supercapacitors 207 and 208 are in balance—that is, when the voltage between rail 203 and junction 210 matches the voltage between junction 210 and rail 204. Additionally, if the voltages have only progressed a small amount—less about 10%—from the ideal equal voltages, then balance 209 continues to draw minimal current.

Each comparator 219 and 220 is powered by the full supply voltage between rails 203 and 204. As it is known that the supply voltage will never exceed a certain value—which, in this embodiment, is 3.9 Volts, the full charge voltage from battery 205—it is possible to use the divided supply voltage as a reference for super capacitors 207 and 208 without the possibility of exceeding the maximum safe operational voltage. Comparators 219 and 220 will function at voltages as low as 1.8 Volts which, if supercapacitors 207 and 208 are in balance, translates to 0.9 Volts across each supercapacitor.

With supercapacitors 207 and 208 in balance, or not having moved sufficiently out of balance, outputs 229 and 230 are “low” and “high” respectively. As this reverse biases both diodes 233 and 235 there is very little current flow through these diodes. Typically, at the operating voltages and temperatures under consideration, such current is extremely small and results in the minimal current draw by comparators 219 and 220. As indicated above, that current is in the order of a few hundred nano-Amps for each comparator.

As the voltage across supercapacitor 207 increases relative to the voltage across supercapacitor 208, it will eventually result in the second reference voltage (at junction 216) being above the voltage at junction 210. That is, eventually the voltage at input 225 will exceed the voltage at input 227. This will cause the output of comparator 219 to go “high” and subsequently forward bias diode 233. Accordingly, a low resistance current path will be established from rail 203 to rail 204 that progresses sequentially tough rail 221, comparator 219, output 229, resistor 232, diode 233, and capacitor 208. This current path is effectively drawing current from rail 203—and hence from supercapacitor 207 and battery 205—to partially discharge supercapacitor 207 and to further charge supercapacitor 208 and thereby restore the voltage balance between the supercapacitors. The current is referred to as a balancing current.

The balancing current is limited primarily by the selection of resistor 232. In the present embodiment, with resistor 232 having a resistance of 383Ω, the balance current is limited to about 3 to 4 mA. In other embodiments, resistor 232 is selected to deliver a different balancing current up to a maximum that is able to be delivered from output 229 of comparators 219. In some embodiments, the maximum balance current is determined by the maximum operational current able to be carried by diode 233.

Comparator 219 includes an inbuilt hysteresis. Accordingly, once the voltage at input 225 falls a predetermined amount below the voltage at input 227, output 229 will be driven “low”. This will reverse bias diode 233 and effectively eliminate the current path referred to above. The hysteresis is, in other embodiments, set at a predetermined value through use of a resistive divider (not shown) that is connected to the appropriate pins (not shown) of comparator 219. For the present embodiment, a typical value of the hysteresis is 4 mV, although this does vary with temperature. Additionally, the 4 mV range is from the top of the band to the bottom. Accordingly, the input has to rise above or fall below the reference by half of this amount before the output will change state.

In this embodiment, the action of the hysteresis ensures that the supercapacitors will never be far out of balance, and that only a small amount of energy will be consumed to progress the supercapacitors toward a balanced state. By way of example only, once the supercapacitor with the higher (rising) voltage changes the state of the respective comparator, that comparator will revert to its original state once the supercapacitor's voltage has dropped by at least the amount of the width of the hysteresis band. As mentioned above, that hysteresis band, in this embodiment, is typically 4 mV. Using these values as illustrative, the energy change in each capacitor is approximately 8.2 mW at the 3.9 Volt supply voltage. It will be appreciated by those skilled in the art that this specific energy change, while indicative, is dependent upon many factors such as the supply voltages, temperature, and the like.

In other embodiments use is made of a different amount of hysteresis and/or a different value of resistance for resistors 232 and 234.

In the alternative, the voltage across supercapacitor 208 increases relative to the voltage across supercapacitor 207. This will eventually result in the first reference voltage (at junction 215) being below the voltage at junction 210. That is, eventually the voltage at input 226 will be less than the voltage at input 228. This will cause the output of comparator 220 to go “low” and consequently forward bias diode 234. Accordingly, a low resistance current path will be established tom junction 210 to rail 204 that progresses sequentially though diode 235, resistor 234, output 230, and rail 222. This current pat is effectively drawing current from junction 210 and hence from supercapacitor 208. Simultaneously, supercapacitor 207 will be drawing current from rail 203—and hence from battery 205—as the voltage at junction 210 is reduced.

The current flow along the current path is limited by the selection of resistor 234.

Comparator 220 also includes an in built hysteresis of about 4 mV. Accordingly, once the voltage at input 226 exceeds a predetermined amount more than the voltage at input 228—in this embodiment the predetermined amount is about 2 mV—output 230 will be driven “low”. This will reverse bias diode 234 and effectively eliminate the current path referred to immediately above. The hysteresis is, in other embodiments, set at a predetermined value through use of a resistive divider (not shown) that is connected to the appropriate pins (not shown) of comparator 220.

When the diodes are forward biased, to operation of balance 209 is to redistribute energy between the supercapacitors and the battery, while dissipating some of the energy from the supercapacitor that is at the higher voltage. However, as the voltages are low, and it is only the difference in voltage across the supercapacitors that is being dealt with, the amounts of energy dissipated in maintaining the voltage balance are also small.

Depending upon the construction and application, it takes a number of hours or days or weeks for the supercapacitors to move out of balance. When this occurs, and one of the comparators switches to forward bias the respective diode, the difference in voltage across the supercapacitors is about 0.4 Volts when the supply voltage is 3.9 Volts. Accordingly, in this embodiment, to return the supercapacitors to a balanced state, and assuming the worst case of all the energy differential being dissipated as heat, would be at a cost of about 8.2 mJ. That is, 8.2 mJ is dissipated when removed from one supercapacitor, while another 8.2 ml is extracted from the supply to “top up” the other supercapacitor. It is important to note that the latter energy is stored in the other supercapacitor and not dissipated.

A resistive balance network, on the other hand, typically continually draws at least 10 times—and in some cases much, much more—the expected maximum leakage current of the supercapacitors. This results in a much larger energy loss than is able to be achieved with the balance shown in FIG. 36. On average, if the resistors of a purely resistive balance carry 10 times the current of the supercapacitors, they will lose 10 times the energy that is lost by the supercapacitors. While in some applications such levels of energy dissipation are entirely acceptable, there are other applications where that would not be acceptable due to the compromised operational lifetime. With use of the FIG. 36 embodiment the steady power required by balance 209 when no re-balancing is required is comparable to the power lost to supercapacitor leakage only, and not 10 times that value or more, as is the case with a purely resistive balance.

The advantages of balances having active, or active and resistive components, become more pronounced for higher temperature applications. Particularly, higher operating temperatures result in high leakage currents from the supercapacitors. Accordingly, for a purely resistive balance to be effective they would be of even lesser resistance. However, this would result in a greater effective power consumption for the resultant balance.

Resistors 211, 212 and 213 are chosen to provide the first and second reference voltages and, as such, their relative resistances are a factor in their selection. However, they are also chosen to have absolutely high resistances to minimise the current that flows through them. That is, as that current flows continually, it presents a constant drain on battery 205 that, if not moderated, will unnecessarily compromise the runtime of device 201.

When supercapacitors 207 and 208 are in balance, or within a voltage range close to the balance voltage, comparators 219 and 220 reverse-bias diodes 233 and 235 respectively and the current drawn by balance 209 is only that required to power the comparators. Assuming a maximum battery voltage of 3.9 Volts, each comparator will draw about 410 nA, and therefore dissipate about 1.6 μW each. It will be appreciated that this nominal value depends upon a variety of factors, including the relevant voltage and temperature. The total approximate power requirements of balance 209—without the use of the optional balancing resistors—is about 3.5 μW at 3.9 V.

Diodes 233 and 235 are low-leakage, in that minimal current flows through them when reverse-biased. In this case, the reverse bias current is in the order of a few nA at the voltages used.

Preferably, supercapacitors 207 and 208, or any other capacitive devices used, also have low-leakage properties. In this embodiment the EPR of supercapacitors 207 and 208 is in the order of 2 MΩ at the voltages and currents experienced. To minimise these leakage currents through the supercapacitors and to ensure a maximum runtime for device 201, the supercapacitors are preferentially selected to include even higher EPR's, This also has the advantage of allowing balance 209 to function more effectively. In a particularly preferred embodiment use is made of supercapacitors sold by cap-XX, Inc and designated as model no GS105 which include an EPR of about 2 MΩ.

The approximate current consumption of balance 209 with the supercapacitors in a balanced state is provided in the following table, where the separate components are separately detailed.

| | | |
|---|---|---|
| Component(s) | Current | Voltage |

| | | | |
|---|---|---|---|
| Resistors 211, 212 and 213 | 80 | nA | 3.9 V |
| Comparator 219 | 410 | nA | 3.9 V |
| Comparator 220 | 410 | nA | 3.9 V |
| TOTAL | 900 | nA | |

Balance 209 is designed for an application whore the voltage maintained by battery 205 during the operational life of circuitry 202 always exceeds the minimum operational voltages required by comparators 219 and 220. In this embodiment that minimum is 1.8 Volts and, as such, that criterion is satisfied, as circuitry 202 requires at least 2.5 Volts between terminal 203 and 204 to function. That is, at all times during that operational lifetime, comparators 219 and 220 will be operative to achieve voltage balancing between supercapacitors 207 and 208.

The embodiments of the invention are applicable to a variety of applications, including; notebook PCs; barcode scanners; PDA's; CF Cards such as those implementing GSM and/or GPRS functions; PC Cards such as those implementing GSM and/or GPRS functions; digital cameras; camera flashes; strobe lights; toll transponders/tags; restaurant paging devices; remote controls for televisions and other electronic devices; toys, including cars, boats, radio-controlled devices such as model aircraft and other toys; photo-voltaic cells/panels; solar-powered devices, including calculators, watches, lights, beacons (marine and aviation); isolated/remote telephone systems; telephones, including cordless telephones, cellular telephones, satellite telephones and other communication devices; garden lighting (especially solar); flashlights; fuel cells; portable electronic equipment; robotics, including robotic actuators; solenoid actuators, including those remote from the supply; short-duration, high-current actuators; electric and hybrid-electric vehicles; prosthetic limbs; sonar buoys; warning buoys; power tools; fuel cell-powered devices; and the like. Device 209, however, being implemented with two comparators, is best suited to those applications requiring relatively low-power balancing and/or those applications in which the balancing is required to work at voltages of down to 0.9 Volts per capacitor when balanced.

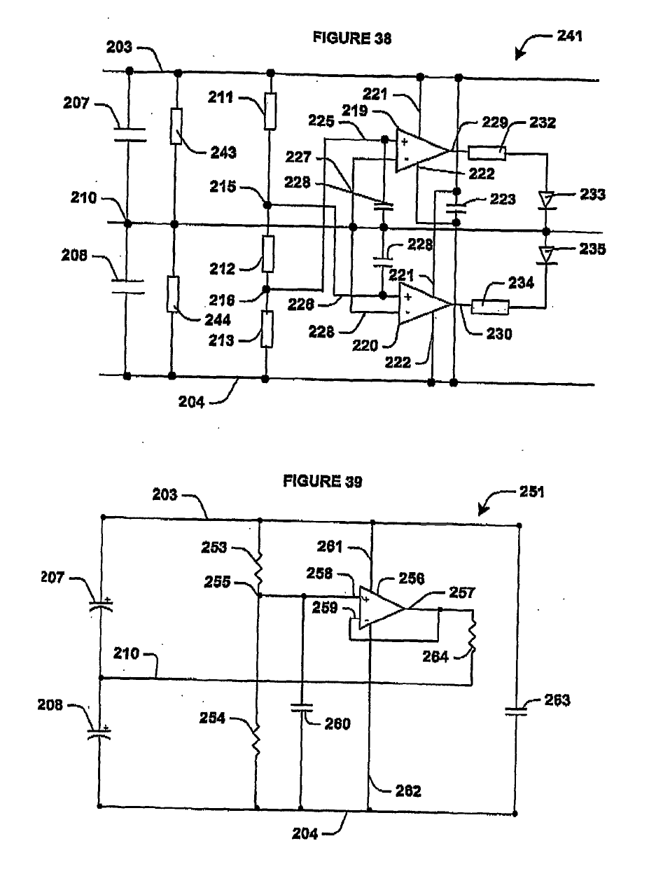

Other embodiments of the invention include provision for periods of operation where the voltage between rails 203 and 204 does temporarily fall below the minimum required to operate comparators 219 and 220. One such embodiment is a balance 241 that is illustrated in FIG. 38, where corresponding features are denoted by corresponding reference numerals.

The additional components included within balance 241 over balance 209 are the two balance resistors 243 and 244, both of which have a resistance of 10 MΩ. Resistor 243 extends between rail 203 and junction 210 to be in parallel with supercapacitor 207, while resistor 243 extends between junction 210 and rail 204 to be in parallel with supercapacitor 208. These resistors function as balance resistors, although differently due to the operation of the other components within balance 241. Particularly, the balancing resistors are not selected to ensure that the current through those resistors is much greater than the leakage current of the supercapacitors at the expected temperatures and voltages of operation. That is, a purely resistive balance, to achieve that effect, has resistance values that are normally selected to draw a current that is about 5 times to 10 times the leakage current of the supercapacitors. However, in this embodiment, resistors 243 and 244 are not chosen on the same criteria, as they are only required to operate when the voltage between rails 203 and 204 falls below 1.8 Volts, which is the minimum required to operate comparators 219 and 220. Accordingly, the resistance of resistors 243 and 244 is greater than would otherwise be expected, as the balancing currents at the lower voltages will be relatively small. This has the added benefit of allowing resistors 243 and 244 to be selected to minimise the current they carry when the supercapacitors are in a balanced state.

The inclusion of resistors 243 and 244 results in an additional 0.2 μA being drawn by the circuit on the basis of battery 205 providing 3.9 Volts. With reference to the above table, that results in a total current of about 1.1 μA being drawn from battery 205 by balance 241 while the supercapacitors are in the balanced state.

Even in circumstances where the comparators are not provided with sufficient voltage to provide continuous operation, some comparators will not require balancing resistors 243 and 244. This is the case where the comparators, when non-operable, do not allow a low resistance current path to be established and all behave similarly so that there is no imbalance. This will not occur where the comparator, although not operating, maintains the respective diode in a forward biased state, or if the output impedance of the comparator is sufficiently high to prevent any substantive current flow to cause a subsequent imbalance between supercapacitors 207 and 208.

The inclusion of resistors 243 and 244 is not due to a concern about an imbalance between supercapacitors 207 and 208 while at the low voltage. It is primarily to do with the voltage imbalance that will come into effect once the fill supply voltage is restored. If that restoration occurs quickly, as it typically does, there is a risk of exposing one of the supercapacitors to an unacceptable high voltage. An example of such an event is when battery 205, once spent—in that it is only providing a voltage of about 2.5 Volts—is replaced with a fully charged like battery that provides 3.9 Volts.

Balance 209 acts to restore balance to supercapacitors 207 and 208 when an imbalanced voltage distribution is detected. In the above embodiments the restoration is achieved predominantly through dissipation. That is, the supercapacitor at the higher voltage is discharged through a dissipative resistor. In response to this the battery is forced to further charge the supercapacitor at the lower voltage. In other embodiments restoration is achieved by one or a combination of techniques, including discharging the capacitor that is at the higher voltage, or by removing charge from the capacitor with the highest voltage and transferring it into one or more of the other capacitors in the circuit.

The primary advantages of balance 209 are:
1. It is only in a high power and energy consumption mode when required to progress the supercapacitors toward the balanced state, and it is otherwise in a low power and energy consumption mode.
2. Very small amounts of power are consumed when the supercapacitors are in a balanced state, thereby allowing for improved runtime for battery-powered devices.
3. Balancing resistors need not be used, thereby preventing the draining of considerable energy from the battery or other source even when the supercapacitors are in balance.
4. Even if balancing resistors are used, higher values of resistances are effective to achieve the required functionality, thereby minimising energy losses.

While the above embodiments have all been provided in the context of a battery supplied circuit, they are equally applicable to circuits having other forms of power sources, be they other energy storage devices, a mains supply, or otherwise.

The net effect of device 201 is that the effective average leakage current of the pair of supercapacitors is made to be equal to that of the one with the higher leakage. For the particular supercapacitor used in FIG. 36, these leakage currents are typically in the order of 0.1 to 5 μAmps. Accordingly, even if the two supercapacitors were at opposite ends of that range, the additional current flow is small and, hence, the additional power consumed is also small. That is, device 201 offers an energy effective means of balancing the supercapacitors. To optimise the operation of balance 209, supercapacitors 207 and 209 are matched for EPR values prior to inclusion within device 1. However, typically that is not done for, as implied above, so long as both the supercapacitors have leakage currents below the value in their specification, the net leakage of the pair will be within specification when use with the above-described preferred embodiment of the invention.

Reference is now made to FIG. 39 where there is illustrated a alternative balance 251 that is able to be substituted for balance 209 of FIGS. 36 and 37. That is, device 251 is used to provide a voltage balance for supercapacitors 207 and 208. In this case, the supercapacitors are each 0.5 Farad carbon double layer devices having a maximum quoted operational voltage of 2.3 Volts. As with the other embodiment, it will be appreciated that balance 251 is applicable to balancing other energy storage devices such as capacitors.

Balance 251 includes a resistive divider network having two equal value resistance resistors 253 and 254. These resistors meet at a junction 255 and provide a reference voltage that is half of the voltage between rails 203 and 204. In this embodiment the equal resistance is 33.2 MΩ, although in other embodiments different values are used. As these resistors will continually be dissipating energy from battery 205 they are selected to have a high resistance.

Balance 251 also includes a MAX4470 operational amplifier 256 that is set up in a voltage follower configuration with junction 255. More particularly, amplifier 256 includes an output 257, a positive input 258 that is directly connected with junction 255, and a negative input 259 that is directly connected to output 257. A 10 nF electrolytic capacitor 260 extends from input 258 to rail 204 to filter high frequency transients.

While resistors 253 and 254 are selected to have high resistance, the upper value for that resistance is dictated by the size of the bias current drawn by amplifier 256. That is, the bias current generates an error, and this has to be accommodated in the design of the circuit as a whole. In this embodiment, the bias current for amplifier 256 is typically about 0.2 nA (although with a maximum of about 4.25 nA) and resistors 253 and 254 have been selected to maintain the voltage error to within about 50 mV of half the voltage between tails 203 and 204.

Amplifier 256 includes a positive supply rail 261 that is connected to rail 203, and a negative supply rail 262 that is connected to rail 204. That is, in this embodiment, amplifier 256 operates at the full voltage provide by battery 205.

A 100 nF capacitor 263 is connected between rails 203 and 204 to minimise high-frequency noise on the power supply to the operational amplifier.

Output 257 of amplifier 256 is connected to one end of and drives a 470Ω resistor 264. That resistor, at its other end, is connected to junction 210.

Amplifier 256 operates in voltage-follower mode, and the reference voltage is one half of the supply voltage between rails 203 and 204. That is, output 257 is driven to be substantially the same voltage as the reference voltage. Inevitably, the internal leakage current in one of supercapacitors 207 and 208 is larger than that in the other, and the voltage at junction 210 will change such that the voltage on the supercapacitor with the larger leakage current will reduce. When this happens, amplifier 256 will drive a current through resistor 264 in a direction to reduce the voltage change and thereby maintain the voltage balance between supercapacitors 207 and 208.

The current that will flow through resistor 264 after a long period of steady-state conditions will be approximately equal to the difference between the leakage currents of the pair of supercapacitors 207 and 208. With an acceptable limit on allowed leakage current in the manufactured device and good initial matching of supercapacitors 207 and 208, the greater leakage current of the two will be acceptable and will not vary greatly and thereby further minimise the power consumption of balance 251.

The value of resistor 264 determines how quickly the balancing current increases as the voltage imbalance increases. The value also determines how quickly an imbalance will be corrected, provided amplifier 256 is capable of sourcing or sinking the balance current required.

While amplifier 264 is stable in the configuration shown, some amplifiers are not when provided with a capacitive load of the magnitude shown. Accordingly, the designer needs to take this into account when selecting amplifier 256. Such selection includes developing and simulating test circuits thoroughly, noting that high-value supercapacitors, such as supercapacitors 207 and 208, often appear to amplifier 256 more like purely resistive loads than capacitors.

Balance 251 draws a minimum of current until a voltage imbalance appears on supercapacitors 207 and 208. Moreover, even when that imbalance occurs, the increased current demanded by balance 251 is only that current required to maintain an approximate voltage balance. That is, the required dissipation current—or balancing current—is substantially equal to the difference in the leakage currents. This is considered a near-optimal current drain from battery 205 for a balancing circuit such as balance 251.

The approximate current consumption for balance 251, when supercapacitors 207 and 208 are balanced, is shown in the following table, where the separate components are separately detailed.

| | | |
|---|---|---|
| Component(s) | Current | Voltage |

| | | | |
|---|---|---|---|
| Resistors 253 and 254 | 140 | nA | 4.6 V |
| Amplifier 256 | 710 | nA | 4.6 V |
| TOTAL | 850 | nA | |

The current for amplifier 256 is a typical value for that amplifier operating at 4.6V and room temperature. At higher temperatures that current will be higher. For example, at 70° C. the typical current value drawn by amplifier 256 is 820 nA. It will be appreciated, however, that for the entire operational temperature range of amplifier 256 the maximum current steady state current drain, at 4.6 Volts, is 1.2 μA.

Device 251 uses a single op amp and is able to operate at voltages of about 2.25 Volts (across rails 203 and 204) and above, up to a value determined by the capacitors and/or the op amp. The applications best suited for device 251 include those requiring low-power balancing. Examples of such applications include notebook PCs, barcode scanners, PDAs, CF Cards—be they GSM, GPRS, or the like, PC Cards—be they GSM, GPRS, or the like, digital cameras, camera flashes, strobe lights, toll transponders or tags, restaurant paring devices, remote controls for TVs or other electronic devices, toys—including cars, boats, etc., radio-controlled devices, including toys, solar-powered devices including calculators, watches, lights, and beacons for marine and aviation purposes, isolated telephone systems, telephones including cordless telephones, garden lighting including solar lighting, flashlights, photo-voltaic cells or panels, fuel cells, portable electronic equipment not already mentioned, robotics including robotic actuators, solenoid actuators, remotely-located short-duration high-current actuators, electric vehicles, prosthetic limbs, other communication devices, and power tools. With the benefit of the teaching herein the skilled addressee will appreciate other such applications of the embodiments and their equivalents.

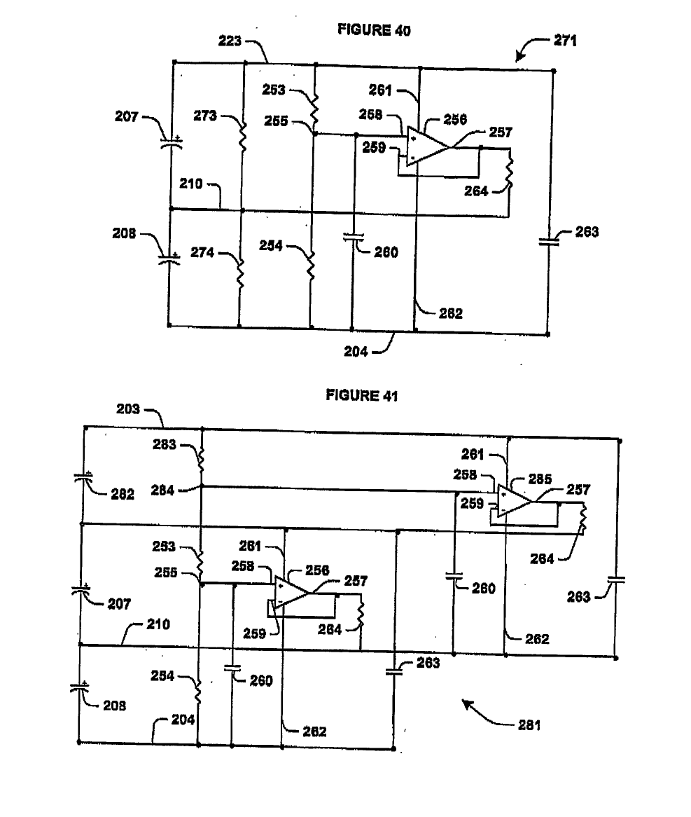

An alternative embodiment of the invention, a protection device 271, is shown in FIG. 40, where corresponding features are denoted by corresponding reference numerals. Device 271 is similar to device 251, and operates similarly, but includes two additional balance resistors 273 and 274 each having a resistance of 11.5 MΩ. These resistors are similar to resistors 243 and 244 of FIG. 38, and are included to provide the same functionality. While some applications will require the functionality offered by resistors 273 and 274 it does ultimately increase the current demanded by device 271. In the present instance, and assuming that battery 205 provides a fully charged voltage of 4.6 Volts, the additional current being drawn is about 0.2 μA. Accordingly, the total steady state current consumption of device 271 is about 1.05 μA at room temperature.

Devices 251 and 271 gradually progress between a high resistance state and a low resistance state in response to supercapacitors 207 and 208 being “in-balance” and “out-of-balance”. As the devices are progressed toward the low resistance state only when an imbalance exists, the current drawn from battery 205 is minimised.

Devices 251 and 271 are intended to protect and balance two supercapacitors, as illustrated. However, both devices are able to be extended to protect and balance any number of supercapacitors or other capacitive elements. For example, FIG. 41 illustrates a protection device 281 to balance three supercapacitors 207, 208 and 282. For convenience, corresponding features are denoted by corresponding reference numerals. It will be appreciated by a skilled addressee, from the teaching herein, that devices 251 and 271 are able to be further expanded to balance more than three supercapacitors or other capacitive components. In those embodiments where there are a large number of series connected supercapacitors it has been found that the bias currents drawn from the resistive divider voltage reference will present a practical limit to the number of op amps that are able to be connected. However, this is addressed by adding, if necessary, a second or subsequent resistive divider.

Supercapacitor 282 is added at the top of the circuit and an additional resistor 283 added to the voltage divider network and extends between the supply rails 203 and 204. Resistor 283 provides a second reference voltage at junction 284 for a second amplifier 285. As shown, amplifier 285 draws power from rail 203 and the mid-point of supercapacitors 207 and 208—that is, junction 210. In other words, device 281 includes certain elements of device 251 that are replicated, with the notable exception of the resistive divider network. This is, in effect, a cascaded arrangement, as each amplifier balances two adjacent supercapacitors. That is, to balance n supercapacitors requires (n−1) amplifiers, but only one resistive divider network having n resistors.

In some embodiments it is necessary to reduce the resistor values 253, 254 and 283 in the resistive divider network to reduce to an acceptable level—for the required application—the voltage error that occurs as a result of the combined bias currents required by the amplifiers. In a steady-state condition, if the supercapacitors have exactly the same leakage currents, the currents used to power the amplifies will partly be provided by the outputs of adjacent amplifiers. To minimise this effect, the amplifiers are selected to have not only a low steady-state power consumption, but also a high input impedance.

Returning to FIG. 40, device 271 is intended to operate in conditions in which the supply voltage—that is, the voltage between rails 203 and 204—remains above the minimum value required to operate amplifier 256. In this embodiment, amplifier 256 operates correctly provided the supply voltage is above about 2.25 Volts. This is also allowing for the common-mode voltage requirement with equal voltages on the capacitors, and up to 50 mV input bias current error. The upper supply voltage limit for device 271 is determined by the lower of the maximum allowable combined voltages for capacitors 207 and 208 and the maximum voltage limit for amplifier 256. The latter, in this embodiment, is 6 Volts.

In other embodiments device 271 is applied to circuits where the supply voltage falls below that minimum. To ensure that the supercapacitors are maintained in balance, notwithstanding the temporary non-operation of amplifier 256, device 271 includes balancing resistors (not shown) disposed in parallel with the supercapacitors. As described with reference to the earlier embodiments, the value of the balancing resistors is selected to minimise the imbalance they permit, given the conditions in which the protection device functions.

If the output impedance of amplifier 256 is sufficiently high it is possible for device 271 to operate at the low supply voltages without the need for balance resistors. However, if amplifier 256 has low output impedance at the low supply voltages, and it tends to drive the voltage at output 257 away from the reference value, then it will inevitably cause capacitors 207 and 208 to become unbalanced. This, in turn, increases the risk of damage to one or other of supercapacitors 207 and 208 when the supply voltage is again increased or the supply is reconnected.

Amplifier 256 will also stop operating correctly if the voltage between rails 203 and 204 drops such that the voltage at the input to the amplifier rises above the specified value of common-mode voltage. This common-mode voltage is the permitted range for both input voltages for the correct functioning of the op amp. For the op amp used in this embodiment, the range is between ground—that is 0 Volts—and the voltage of the positive supply rail less 1.1 Volts. As will be appreciated by those skilled in the art, if either input of the op amp goes above the upper value, the op amp will not function correctly.

Device 271 is best suited to those applications requiring balancing at very low supply voltages—from about 1.0 Volt—but where it is possible, within the overall design constraints, to draw a higher supply current than the other embodiments referred to above.

While device 271 includes balance resistors 273 and 274, this same effect is achieved in other embodiments (not shown) through using device 251, but with resistors 253 and 254 having a reduced resistance value so as to flow the currents required to perform the balancing functionality in addition to the voltage dividing functionality. Clearly, the resistance of resistors 253 and 254 in such an embodiment remains proportionally the same to ensure the voltage dividing functionality is similarly performed.

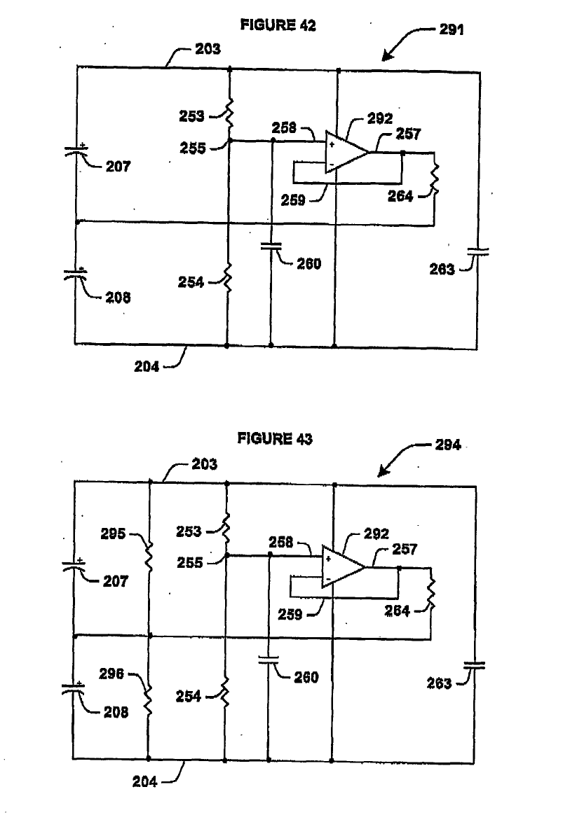

A further embodiment of the invention is illustrated in FIG. 42, where corresponding features are denoted by corresponding reference numerals. Particularly, a protection and balance device 291 is similar to device 271 and operates in the same way to provide active balancing and protection for supercapacitors 207 and 208. However, device 291 is configured for low voltage operation, and provides active balancing and protection for supply voltages as low as about 1 Volt.

In this embodiment, supercapacitors 207 and 208 are 100 Farad carbon double layer devices having a stated maximum operation voltage of 2.3 Volts. In other embodiments supercapacitors and capacitors of other capacities are balanced and protected. The op amp used in this embodiment draws a high current relative to the embodiments described above, but is able to function at lower voltages. That being so, this embodiment is best suited to those applications involving high energy and power consumption and, typically also, where high capacitance supercapacitors are required. An example of such applications include electric and hybrid electric vehicle. That said, device 291 is also suitable for lower-power applications for, although the current the op amp consumes is typically greater than nine times that of the earlier described embodiments, it is still, in absolute terms, a low-power protective and balance device.

Resistors 253 and 254 each have a resistance of 3.32 MΩ, while resistor 264 has a resistance of 20Ω. Ceramic capacitors 260 and 263 are both 100 nFarad devices. In other embodiments use is made of other high-frequency type capacitors.

Resistors 253 and 254 have a relatively low value due to:
In a high-capacitance application the leakage currents are relatively high and there is an advantage to keeping the net impedance of the balancing current's source—which comprises the op amp and the resistor—low to minimise the drop across the resistor.
The op amp being capable of driving a relatively high current—in the order of 19 mA at 3 Volts—while also being relatively tolerant of output short-circuits. This allows the op amp's characteristics to limit the current should a supercap develop a high leakage.

Capacitor 260 has a relatively high value to maintain the RC time constant of the sub-circuit comprising the resistors and the capacitor. As use is made in this embodiment of relatively low value resistors, there is a larger capacitance capacitor used to obtain a comparable filtering effect. For practical purposes, cost and size considerations often dictate that the capacitance is not increased to provide exactly the same RC time constant.

Device 291 includes an operational amplifier 292 that is a MAX4289 type.

As with the embodiment of FIG. 40, device 291, while shown to be balancing and protecting two capacitors, is able to be extended to balance and protect any number of capacitors.

The selection of amplifier 292 allows device 291 to operate at a total supply voltage—that is, the voltage between rail 203 and 204—as low as 1.0 Volt. The only precondition for this particular make and model of amplifier is that the voltages at inputs 258 and 259 are maintained below (the supply voltage−0.2 Volts). This precondition is satisfied for most applications. In embodiments where the precondition is not satisfied, use is made of an alternative device 293, which is illustrated in FIG. 43. That is, device 294 is, in effect, device 291 with 115 kΩ balancing resistors 295 and 296.

The above comments and description about voltages outside the common-mode range while the op amp is still operating applies equally to this embodiment. Note that, particularly in this embodiment, the voltage at the non-invert or positive input of the op amp could not get into this range and the voltage at the inverting or negative input of the op amp would only do so if the upper capacitor was nearly discharged while the lower capacitor still had almost a volt across it. This latter condition would be neither normal nor expected.

Although amplifier 292 is able to operate at lower voltages than, say, amplifier 256, it does draw a higher current. This makes devices 291 and 294 best suited for protecting and balancing high capcacitance supercapacitors and capacitors where leakage currents are typically relatively high. However, devices 291 and 294 are also suitable for applications where the typical current consumption of 9 to 18 μA (maximum 40 μA) is not considered disadvantageous.

The approximate current consumption of device 291, with the supercapacitors in a balanced state, is provided in the following table, where the separate components are separately detailed.

| | | |
|---|---|---|
| Component(s) | Current | Voltage |

| | | | |
|---|---|---|---|
| Resistors 253 and 254 | 0.69 | μA | 4.6 V |
| Amplifier 292 | 16 | μA | 4.6 V |
| TOTAL | 16.69 | μA | |

While this suggests that the current consumed in the steady-state will be about 17 μA, it is anticipated that the circuit would more typically consume far less than this as the operating voltages would be less. For example, when the voltage between rails 203 and 204 is 1 Volt, amplifier 292 draws typically about 9 μA (up to a typical maximum of about 14 μA). A further example being, when there is a voltage between rails 203 and 204 of 3.0 Volts, amplifier 292 draws typically about 12 μA (up to a typical maximum of about 25 μA). It will also be appreciated that the maximum current drawn by amplifier 292 when operating at 4.6V is less than 40 μA across the entire range of operating temperatures. These currents are drawn by the protection device when the supercapacitors are nominally balanced, whether this is a steady-state condition or not. The nominally balance state is defined by a zero voltage difference between the inputs 258 and 259 of amplifier 292. It will be appreciated that in the nominally balanced state the supercapacitors may not be exposed to exactly equal voltage. However, typically any difference is small relative to the voltage across the supercapacitors.

For those protection devices such as device 291 that include one or more op amps in a voltage-follower configuration—as opposed to other embodiments that include one or more op amps in a comparator configuration—there is a steady progression in balancing current from the balanced state to the unbalanced state. While resistors 253 and 254 will continually draw current, the balancing current flowing through resistor 264 is zero or very near to zero when the supercapacitors are nominally balanced, but progressively increases as the difference in voltage across supercapacitors 207 and 208 increases. That is, the balancing current increases with increasing voltage unbalance of the supercapacitors.

The current figures contained in the above table are for device 291 when the capacitors are in the nominally balanced state. In this state, device 291 draws the least current and, as such, it is referred to as the high resistance mode, When the voltage across the two supercapacitors is not in balance, greater current will flow through device 291, and this is referred to as the low resistance mode. However, the transition between these modes is progressive and continuous, unlike other embodiments described above where that transition is stepwise.

When device 291 is in the low resistance mode, the current drawn from battery 205 increases, but typically only for a short period, as that is all that would be required to restore the nominal voltage balance.

In the long term and/or in steady-state, the current delivered by device 291 will end up being the difference between the leakages of the supercapacitors. In other words, the balancing current will typically flow almost continually at the value determined by the difference. Larger transient differences will exist, arising from short term effects such as temperature differential between the supercapacitors, or other unequally shared environmental factors.

Device 294, as shown in FIG. 43, due to the inclusion of balancing resistors 295 and 296 draws an additional 20 μA from battery 205 when the voltage between rails 203 and 204 is 4.6 Volts. This provide for a total current drain of about 37 μA at room temperature. In terms of power consumption, device 294 consumes about 170 μW in the low power consumption mode at a supply voltage of 4.6 Volts.

Devices 291 and 294 use an operational amplifier with an internal reference voltage, and are best suited to those applications requiring low-power balancing and where the voltage on each capacitor does not drop below 1.8 Volts. It is also preferred that the supply voltage does not undergo sufficiently wide variations or be periodically or otherwise frequently disconnected. In other words, this embodiment is best suited to those applications where the supply voltage is continually present and ON. In some such applications, use of device 294 is preferred, in that the balancing resistors reduce the risk of one or more of the supercapacitors being exposed to abnormally high voltages when the supply voltage increases after having fallen or being disconnected.

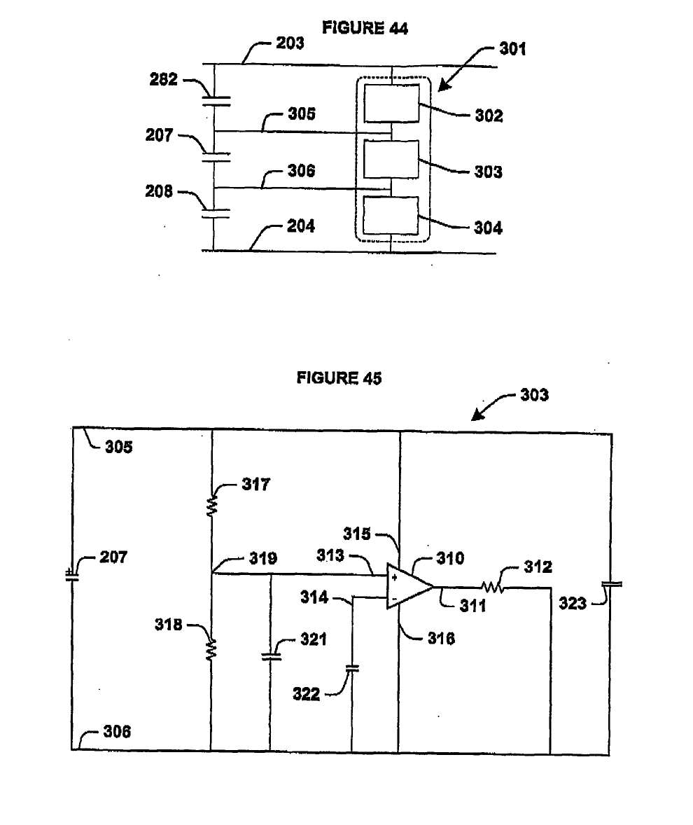

A further embodiment of the invention is illustrated in FIG. 44 and FIG. 45, where corresponding features are denoted by corresponding reference numerals. More particularly, and as best shown in FIG. 44, a protection device 301 (represented by the block in broken lines) includes three separate but like series connected sub-devices 302, 303 and 304. As shown, these sub-devices are in parallel with supercapacitors 282, 207 and 208 respectively.

In this embodiment supercapacitors 282, 207 and 208 are all 0.5 Farad carbon double layer supercapacitors. In other embodiments alternative capacity supercapacitors or capacitors are used. Moreover, while in this illustrative embodiment use is made of three series connected sub-devices, in other embodiments use is made of other numbers of series connected supercapacitors. It will be appreciated by those skilled in the art, from the teaching herein, that each of sub-devices 302, 303 and 304 separately monitors and protects a respective capacitive device. Accordingly, separate sub-devices are able to be cascaded to protect any desired number of series connected capacitors.

For convenience, the conductors—other than rails 203 and 204—that effect a parallel connection of the supercapacitors with the sub-devices, are referred to as rails 305 and 306.

Sub-device 303 will now be described in more detail with reference to FIG. 45. It will be appreciated that the other sub-devices include like components and functionality for the supercapacitors to which they are respectively connected in parallel. Sub-device 303 includes a comparator 310 that is responsive to the voltage across supercapacitor 207 and a reference voltage—that is internally generated by comparator 310—for providing a control signal at the output 311 of the comparator. A discharge circuit, in the form of a 44.2 kΩ resistor 312, is responsive to the control signal for partially discharging supercapacitor 207 to maintain the voltage across the supercapacitor below a predetermined value.

Comparator 310 is a MAX9117 type operational amplifier and includes a positive input 313, a negative input 314, a positive power rail 315 and a negative power rail 316. Rails 315 and 316 are directly connected to rails 305 and 306 respectively and therefore comparator 310 is powered by whatever voltage is across supercapacitor 207.

Device 303 also includes two series connected resistors 317 and 318 that meet at a junction 319 and which collectively extend between rails 305 and 306. That is, the resistors are in parallel with supercapacitor 207 and therefore the voltage at junction 319 is a fixed proportion of the voltage across the supercapacitor. In this embodiment, resistors 317 and 318 have respective resistances of 22.1 MΩ and 29.4 MΩ. Also included are three capacitors 321, 322 and 323 for providing high frequency stability to device 310. In this embodiment capacitors 321, 322 and 323 have a capacitance of 10 nF, 10 nF and 100 nF respectively.

Input 313 is connected to junction 319, while input 314 is connected to rail 306 via capacitor 322. That is, input 313 is responsive to the voltage between rails 305 and 306—albeit in a proportional manner—while input 314, connected to an internal reference voltage, is open-circuit except for high frequency voltages that are shorted to rail 306.

Device 301 is designed for used in applications where the operational voltage between rails 203 and 204 does not drop below 5.4 Volts or, more particularly, where the operational voltage across each of supercapacitors 207, 208 and 282 does not fall below 1.8 Volts.

Comparator 310 includes an internal reference voltage and allows for independent protection of supercapacitor 208. In the embodiments described above, the reference voltage is derived from the voltage between rails 203 and 204, while in this embodiment, the internally generated reference is derived neither from the voltage between rails 203 and 204, nor from the voltage between rails 305 and 306. This decoupling of the reference voltage from the rail voltage allows each sub-device to be independently tailored to the supercapacitor—or other capacitive device—being protected. It also provides for an increased modularisation of the protection function that is easily extended to applications with a different number of series connected capacitive devices requiring protection and balancing,

If the voltage at junction 319 is less than the internally generated reference voltage, comparator 310 will be drawing minimal current, as output 311 will be at substantially the same voltage as rail 306. However, once the voltage at junction 315 rises above the reference voltage, output 311 will be driven to about the voltage at rail 305. This, in turn, creates a current path from rail 305 to rail 306 via rail 315, output 311, and resistor 312. That is, supercapacitor 208 is partially discharged, with that energy being substantially dissipated in resistor 312.

Resistors 317 and 318 are selected so that when the voltage at junction 315 equals the reference voltage, the voltage between rails 315 and 316 is less than the maximum operational voltage of supercapacitor 208. The extent of the safety factor included in this calculation is dependent upon the design parameters and the nature of the capacitive device being protected.

As supercapacitor 208 is discharged, the voltage at junction 319 will fall below the reference voltage. Due to the hysteresis of comparator 310 the discharging will continue, albeit temporarily. Once the delay resulting from the hysteresis has passed, output 311 will again be driven to a voltage substantially the same as rail 306.

Device 303, in this way, toggles between a low power consumption mode—when the voltage across supercapacitor 208 is within the desired range—and a high power consumption mode to bring the voltage across supercapacitor 208 back into that range. This is achieved by creating a relatively low resistance path in parallel with supercapacitor 208 when the voltage across that supercapacitor increases to an undesirable level. However, when the voltage is returned to an acceptable level, device 303 presents a very high resistance path in parallel with supercapacitor 208, in that it draws very little current. Accordingly, the overvoltage protection for supercapacitor 208 is provided without having to consistently draw a relatively high current. In this way, the overall power consumption of the protection and balancing circuitry is reduced without compromising the protection that is provided.

The approximate current consumption of sub-device 303, with supercapacitor 208 held at a “safe” operating voltage, is provided in the following table, where the separate components are separately detailed.

| | | |
|---|---|---|
| Component(s) | Current | Voltage |

| | | | |
|---|---|---|---|
| Resistors 317, 318 | 43 | nA | 2.19 V |
| Comparator 310 | 690 | nA | 2.19 V |
| TOTAL | 733 | nA | |

With resistor 317 and 318 the nominal voltage at which sub-device 303 becomes active and begins to discharge supercapacitor 208 is typically 2.19 Volts. Due to tolerances between like comparators, this value varies between a typical maximum of 2.29 Volts and a typical minimum of 2.10 Volts.

When device 303 is in the low resistance mode—in that a discharging or balancing current is flowing—the discharging current through resistor 312 is about 50 μA given a voltage between rails 305 and 306 of 2.19 Volts. The quantum of the current is set through appropriate selection of the resistance of resistor 312. Examples of this are provided in the following table.

| Resistance (Ω) | Balancing current (mA) |
|---|---|
| 647 | 3 |
| 2.1k | 1 |
| 22.1k | 0.1 |
| 44.2k | 0.05 |
| 86.6k | 0.025 |

At room temperature, comparator 310—a MAX9117 type comparator—typically draws 690 nA at 2.19 Volts. At the same voltage, but 70° C., comparator 310 draws typically less than 820 nA, with a maximum at that temperature and voltage of les than 1.3 μA.

As each of sub-devices 302, 303 and 304 include similar components arranged in a like way, it will be appreciated that when any one of the comparators 310 begins to discharge the corresponding supercapacitor, battery 205 simultaneously charges the other two supercapacitors. This, in turn, restores the voltage balance. When the voltage on the discharging supercapacitor has dropped below the threshold determined by the voltage divider resistors 317 and 318 and the hysteresis inherent in comparator 310, the discharging stops and the current consumption of the circuit returns to that of its quiescent state.

Sub-devices 302, 303 and 304 use an absolute reference voltage to determine when balancing and protection action should commence instead of referencing a proportion of the total voltage across all of supercapacitors being balanced. As a consequence, device 301 is best suited to applications where the operational voltage between rails 203 and 204 typically remains within a narrow range. More preferably, the voltage remains at higher levels. The preferred applications are those where rails 203 and 204 are connected to a mains supply, or where battery 205 is regularly recharged or replaced. Examples of such applications include:
Toll transponders and other devices using long-life batteries that last several years.
Most mains-powered applications.
Applications in which the supercapacitor stores energy locally to provide a brief local high current, such as remotely-located solenoid actuators powered via long/thin wires, or powered from low-current sources.
robotic actuators and robots generally.
In combination with those supercapacitors used at outputs of regulators and DC-DC converters.

The sub-devices are designed so that the voltage at which the balancing action commences is close to the normal operating voltage. More particularly, in this configuration the normal operating voltage for supercapacitors 282, 207 and 208 is about 2 Volts, on the basis that the supply voltage is about 6 Volts. The supercapacitors are each rated for 2.3 Volts. Comparator 310 switches to the high power consumption mode when that voltage reaches 2.19 Volts. This is on the basis that the supply voltage is not expected to drop below about 5.1 Volts in normal use and, when restored to 6 Volts, it raises the voltage on each cap by about 0.3 Volts. That being so, the individual capacitor voltages will not exceed 2.5 Volts (which is their specified short-duration maximum value) before being re-balanced. The sub-devices, in this way, ensure within their design constraints, that, should the supply voltage spend some time at a lower-than-normal value, there will be sufficient safety margin for the supercapacitors with the lowest leakage not to become over-charged once the voltage is restored.

As described above, the voltage across the supercapacitor is determined by the divided value at junction 319. This value is compared with the reference voltage generated internally by comparator 310. For the present embodiment, the reference voltage is nominally 1.25 Volts. The total range of the hysteresis voltage referred to the input is typically 4 mV.

It will be appreciated that the reference voltage provided by comparator 310 varies slightly with the voltage across rails 305 and 306, however, this is typically small for the voltage ranges to which device 310 is applied. The reference voltage also varies with temperature, and this should be taken into account.

Although device 301 is shown in parallel with three supercapacitors, the sub-devices are applicable to series capacitor networks in which two or more capacitors are used.

Device 301 does draw a higher current per comparator than a circuit of the other embodiments that do not use an internally generated reference voltage. However, as the comparator is only operating at a lower voltage—as it is only connected in parallel with a single supercapacitor—the power drawn from battery 205 is reduced.

In other embodiments, device 301 includes a different number of series connected sub-devices corresponding to the number of series connected capacitors requiring protection and balancing. That is, each capacitor is provided with its own balance circuit and, as such, the capacitors need not be the same as each other. That is, the sub-devices are able to be customised for the individual capacitor that is to be protected through the selection of the values of resistors 317 and 318.

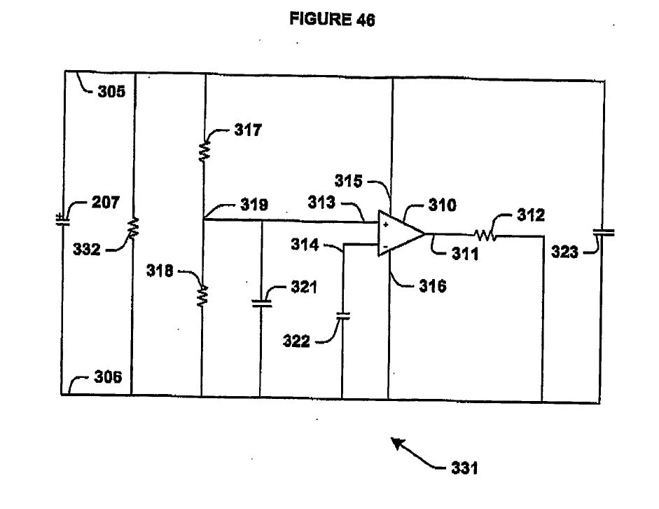

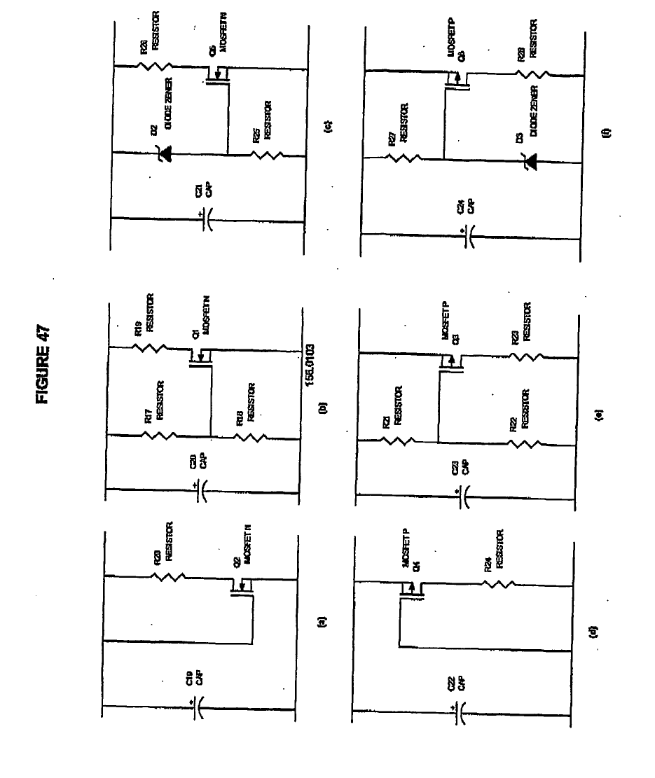

An alternative embodiment of sub-device 303 is illustrated in FIG. 46 where corresponding features are denoted by corresponding reference numerals. More particularly, a sub-device 331 includes an 11 MΩ balancing resistor 332 that is connected in parallel with supercapacitor 208. Resistor 332 is primarily for providing an inherent balance for those applications where a low or non-existent source voltage has to be accommodated. That is, where the voltage between rails 305 and 306 falls below the minimum operating voltage for comparator 310. In this embodiment, that minimum voltage is about 1.8 Volts given that this corresponds to the guaranteed minimum specified operating voltage of comparator 310. However, if the actual comparator 310 operates at a lower voltage due to specification variation, then sub-device 303 will also operate to that lower voltage. In other embodiments alternative comparators are used.

The inclusion of resistor 332 draws an additional and continuous 0.2 μA from battery 205, which places the total current for device 331 in the high resistance mode at about 0.93 μA assuming a 2.19 Volts potential difference between rails 305 and 306.

It will be appreciated by those skilled in the art that the balancing resistor 332 is, in other embodiment, substituted by adjusting the values of resistors 317.

Comparator 310 is preferably selected to ensure that its output does not go high when the supply voltage drops below the minim operating voltage.

Typically, the circuitry 202 rapidly discharges the supercapacitors when the battery is either disconnected or its voltage drops toward the end of its discharge cycle. As the capacitors are usually in balance just prior to that event, imbalance and overvoltage problems are unlikely to arise.

Sub-device 303, and like devices, do not require a diode between output 311 and the lower rail as output 311, when low, is very close the voltage on rail 306. In embodiments where the selected comparator does provide a small voltage at output 311, when low, then a diode may be added. Particularly, the anode of the diode is connected to resistor 312, and the cathode to rail 306. This reduces the current that is drawn when in the high resistance mode. However, to ensure similar performance in the low resistance mode, the value of resistor 312 is adjusted due to the inherent voltage drop that will exist across the diode when forward biased

Applications for the sub-devices 303, 304 and 305 include: notebook PCs; barcode scanners; PDAs; CF cards, be they GSM, GPRS, or otherwise; PC cards, be they GSM, GPRS, or otherwise; digital cameras; camera flashes; strobe lights; toll transponders or tags; restaurant paging devices; remote controls for TVs, and other electronic appliances or apparatus; toys, including cars, boats, and the like; radio-controlled devices, including toys; solar-powered devices, including calculators, watches, lights, and beacons, be they marine, aviation or otherwise; isolated telephone systems; other communication devices; telephones, including cordless telephones; garden lighting, particularly solar lighting; flashlights; photo-voltaic cells/panels; fuel cells; all portable electronic equipment; robotics and robotic actuators; solenoid actuators, remotely-located, short-duration, high-current actuators; electric and hybrid electric vehicles; prosthetic limbs; sonar buoys; power tools; and others.

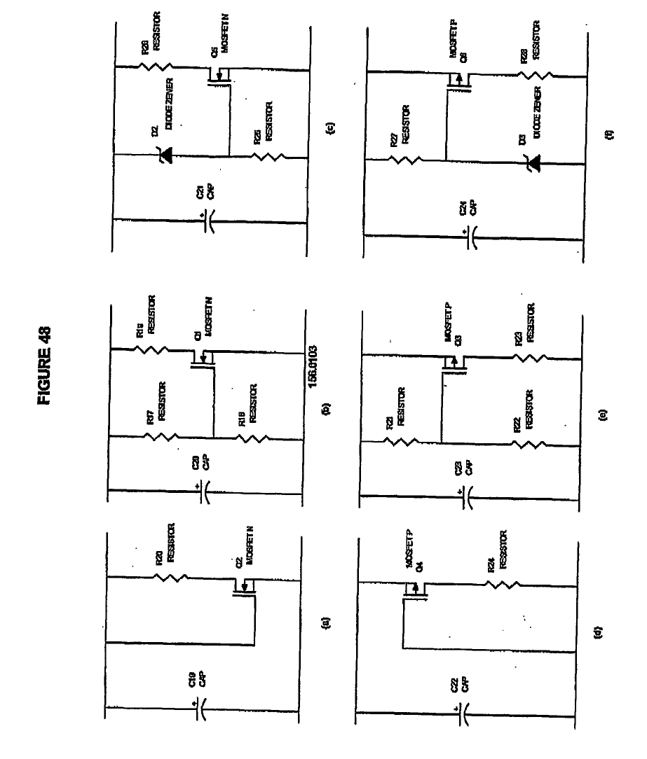

Reference is now made to FIGS. 47 and 48 where there are illustrated further embodiments of the invention, all of which are based upon active components. These circuits are simple and cost effective to construct and implement, although typically will have higher power consumption than a corresponding one of the earlier described embodiments. Moreover, these embodiments are better suited to those application which enjoy a more limited temperature range. This makes them ideal for low-cost applications such as toys of various sorts. Other applications include: electronic camera flash circuits; strobe circuits; robotic actuators and robots generally; fuel cell-powered devices; restaurant paging devices; actuators at the end of a long/high-resistance power lead that are either mains-powered or in which the current drain of the circuit is not a serious consideration; or other applications where recharging of the supercapacitors or other capacitive devices occurs frequently.

Turning first to the embodiments in FIGS. 47(a) to (f), the active devices include MOSFETs and diodes. In all cases, the circuits are intended for applications in which multiple capacitors are connected in series. For convenience, only one of the capacitors to be balanced is shown, and this is on the left hand side of each circuit. Other like circuits, with corresponding capacitors, are connected above and/or below the respective circuit.

These circuits are also used in applications where the ambient temperature is relatively stable and where the threshold turn-on voltage of the MOSFET being used is known at that temperature. The latter is typically satisfied either because the MOSFET has a well-defined threshold voltage specification, or because the particular MOSFET was selected for its known and matched threshold voltage value.

Since the threshold voltage of a MOSFET is temperature-dependent, the uses of the circuits illustrated in FIG. 47 are best limited to those applications in which the temperature variation is small and in which the capacitors are not used at or near their full voltage ratings. This ensures that there is a wide safety margin in the value of the capacitors' voltages without risk of a capacitor going over-voltage.

The voltage at which the MOSFET begins to turn on determines the voltage at which the corresponding capacitor will settle, in steady-state conditions. Those circuits using a zener diode reference—FIGS. 47(c) and 47(f)—will suffer from less variability. Notwithstanding, the lack of a consistent external control of the switching voltage may require careful selection and matching of components to gain a consistency of protection and balance across a bank of capacitors.

For some MOSFETS, the off-state leakage current—that is, with V_{GS}=0 Volts—is significant. These components, when included in the circuits of FIG. 47, limit the application of those circuits to capacitors that have relatively high leakage currents.

Zener diodes also have relatively high leakage currents, so the resistors in series with them must be chosen carefully so that the voltage at the gate of the MOSFET does not begin to rise until the correct voltage is reached.

The circuits of FIGS. 47(a) and (d) are the simplest, and rely an the MOSFET turning on and beginning to “leak” current from the corresponding capacitor when the voltage across the supply reaches the threshold voltage.

In all the FIG. 47 circuits, the resistor in series with the drain of the respective MOSFET determines, in combination with the MOSFET's characteristics, the rate at which the balancing current increases with voltage.

The circuits in FIGS. 47(b) and (e) deliver a divided voltage to the gate, thus increasing the effective threshold voltage of the circuit.

The circuits in FIGS. 47(c) and (f) are intended to turn on shortly after the voltage has risen past the zener diode's breakdown voltage. The resistor in combination with the diode is low enough in value that the diode does not begin to increase the voltage at the gate of the MOSFET before the supply has reached the actual breakdown voltage. In other embodiments, the zener diode is substituted with a low-power—that is, a low current—voltage-reference device. Such devices, though more complex in their internal design, typically provide a more accurate turn-on voltage.

Reference is now made to FIGS. 48(a) to (d), where there are illustrated alternative embodiments of the invention where the active devices include bipolar transistors and diodes. These circuits are relatively simple and are also best used where cost is a predominant design parameter. With careful selection and matching of components all the circuits function to protect the corresponding capacitor and balance a bank of series connected capacitors. That said, the temperature-sensitivity and gradual turn-on of the transistors makes these circuits less suited to those applications requiring precise voltage balance points and relatively low currents in the balancing circuits.

Again, it will be appreciated that FIG. 48(a) to (d) show only one portion of each circuit, with the other capacitors to be protected and balanced, and their corresponding balancing circuits, being omitted for the purposes of clarity. As with circuits such as that shown in FIG. 45, the FIG. 48 circuits are cascaded together with a series bank of capacitors.

The circuits illustrated in FIG. 48(a) and (c) are the simplest and least tolerant to component variation. As the voltage across the capacitor to be balanced increases, the transistor gradually turns on, passing progressively higher and higher currents. The quantum of the current is dependent upon the value of the collector resistor and the gain of the transistor. The best results are achieved when these circuits are used in an environment with stable temperature, with transistors that were selected for matched characteristics.

The circuits illustrated in FIGS. 47(b) and (d) use a voltage reference device, in this case a zener diode. In other embodiments, however, use is made of a low-current voltage reference IC. The components are selected such that the transistors begin to turn on at about the desired voltage balance point. The value of the balancing voltage is under better control than in the circuits illustrated in FIGS. 48(a) and (c).

These circuits are best used in applications in which there is some safety margin between the normal operating voltage on the capacitors and the maximum tolerable voltage. Moreover, the circuits are preferably designed to discharge the respective capacitor when the voltage begins to exceed the normal operating level. This leaves considerable margin for errors due to temperature change or mismatches in components.

The circuits of FIGS. 48 (a) and (c) are also best applied to high leakage current capacitors, as the currents flowing through the voltage-reference devices prior to reaching their reference voltages tends to be high relative to other embodiments of the invention. Moreover, the circuits tend to turn on gradually.

In the above embodiments of the invention there are provided examples of suitable active components. In other embodiments, use is made of other similar components or combinations of components that provide an equivalent functionality. With the benefit of the teaching herein, such similar components or combinations of components would be known to those skilled in the art.

It will be appreciated by the skilled addressee that the active components used in the preferred embodiments are selected in light of the power supply and load characteristics with which the respective embodiment is designed to operate. It will also be appreciated by that addressee that for active components, such as those disclosed in the above embodiments, there are variations between like designated devices, and consideration may have to be given to ensuring that these variations are not such that like circuits incorporating apparently like devices exhibit sufficiently different behaviours, particularly when the power supply is turned off, or its voltage reduced below the level at which the active components function normally. For example, in this condition, the active components—that is, the op amps—should prevent the load from discharging the capacitors in a short time. Another example is for those embodiments where two op amps are used, and where consideration may have to be had to the current consumption for each op amp, and to ensure that it represents a balanced load on the capacitors. A further example is where a single op amp is used, and where regard may have to be had to ensure that the output of that op amp does not attempt to discharge one of the capacitors.

In all the embodiments described above the balancing resistors are optional. It has been found by the inventors that their inclusion or omission is typically determined in the light of the way the active components behave when the supply voltage drops to low levels, or in light of the magnitude of any currents that flow to cause an imbalance between series connected capacitors that are being balanced. In those applications where the power supply—typically a battery—remains connected (that is, the power remains ON continuously) the balancing resistors are not normally needed. In those embodiments that are battery powered and where the balance resistors are omitted, there is a benefit of a greater run time over the equivalent circuit with the balancing resistors.

While the above embodiments have been described with reference to balancing one or more supercapacitors, they are also suitable for balancing a corresponding number of other capacitive devices.

The embodiments of the invention have been developed to overcome the inherent problems of matching supercapacitors. The result being that the embodiments are able to operate over a greater range of environmental conditions, and to better accommodate the tolerances required by specific applications.

Through use of the embodiments of the invention, it is possible to increase the operating voltages of the cells which allows less cells to be used in series for operation at a given voltage. Moreover, because there is certainty of even voltages across the cells in a series, it is possible to dispense with the more conservative safety factors required for prior art series connected cells.

Due to the higher operating voltage, each cell provides a higher energy density and power density.

The embodiments of the invention deal not only with the issues of static difference between cells, but also the dynamic changes that inevitably occur once the cells are incorporated into supercapacitors and applied into electronic circuits.

There are supercapacitors and other energy storage devices that include asymmetrical cell geometries or other factors that result in the opposed electrodes having different capacitances. The embodiments of the invention are also applicable to such devices as the overall cell voltage is still being balanced relative to series connected cells.

Applications for the embodiments of the invention include: notebook PCs; barcode scanners; PDAs; CF cards, be they GSM, GPRS, EDGE, UMTS, 3G or otherwise; PC cards, be they GSM, GPRS, EDGE, UMTS, 3G or otherwise; digital still cameras; digital video cameras; digital single lens reflex cameras; camera flashes; strobe lights; toll transponders or tags; RFID tags; automatic meter readers and systems; UPS systems; load levelling systems; restaurant paging devices; remote controls for TVs, and other electronic appliances or apparatus; toys; including cars, boats, and the like; radio-controlled devices, including toys; solar-powered devices, including calculators, watches, lights, and beacons, be they marine, aviation or otherwise; isolated telephone systems; other communication devices; telephones, including cordless telephones; garden lighting, particularly solar lighting; flashlights; photo-voltaic cells/panels; fuel cells; all portable electronic equipment whether battery powered, fuel cell powered or otherwise; robotics and robotic actuators; load control and balancing devices for electric motors; solenoid actuators; remotely-located, short-duration, high-current actuators; electric and hybrid electric vehicles; prosthetic limbs; sonar buoys; power tools; and others.

It will be understood by those skilled in the art that the invention is applicable to both high and low power devices and systems.

Some of the examples provided in Appendix 1 include data for the energy storage devices with the associated housing, while others have been corrected to remove the effect of that housing. The latter is intended to demonstrate the effective thickness and densities of the cells per se, without reference to packaging material.

That said, for practical applications, there is a need to include the housing within the calculations. There are a variety of housings available, one of which is referred to in PCT patent application PCT/AU01/00838, the disclosure of which is incorporated herein by way of cross reference.

It is illustrated in FIG. 11 that charge currents and/or leakage currents of at least 120 μA are not uncommon for the embodiments illustrated above. With such a current from a dual-cell device, with an operating voltage of 4.5 Volts, the total effective resistance of the device is about 37.5 kΩ. Accordingly, to limit the voltage across one cell to 2.7 Volts to prevent cell damage, the voltage across the other cell is 1.8 Volts and its effective resistance is 15 kΩ.

In those embodiments relying upon a balance having only one or more resistive components, a conservative resistance value to include in parallel with each cell is less than about 15 kΩ. Given the desire for a safety factor, it has been found that the minimum resistance value for use in such embodiments is about 10 kΩ. However, in other embodiments, where long life of the energy source is the predominating design criteria—for example for mobile applications—use is made of higher resistance values. Accordingly, in some other embodiments, the resistance values are at least 39 kΩ. More preferably, the resistance values are greater than about 100 kΩ, and even more preferably, greater than about 270 kΩ. In further embodiments, the resistance values are greater than about 330 kΩ, and more preferably greater than about 390 kΩ. It is also possible, in alternative embodiments, to utilise higher resistance values, which in some embodiments are greater than about 470 kΩ. It has been found that where use is made of long life batteries, that resistance values of greater than about 680 kΩ are advantages. In some embodiments, the resistance values are greater than about 1 MΩ.

Although the invention has been described with reference to specific examples, it will be appreciated by those skilled in the art that it may be embodied in many other forms.

### APPENDIX 1

| | | | Operating | | | | | | | Time |
|---|---|---|---|---|---|---|---|---|---|---|
| Example | Capacitance | Resistance | Voltage | Mass | L | W | H | Volume | Density | constant |
| # | (F) | (mΩ) | (V) | (g) | (mm) | (mm) | (mm) | (cm³) | (kg/l) | (s) |
| 1 | 0.22 | 57 | 4.50 | 1.90 | 39.00 | 17.00 | 1.73 | 1.15 | 1.65 | 0.0124 |
| 2 | 0.25 | 72 | 4.50 | 1.35 | 28.50 | 17.00 | 2.02 | 0.98 | 1.38 | 0.0183 |
| 3 | 0.03 | 319 | 4.50 | 1.08 | 28.50 | 17.00 | 1.46 | 0.71 | 1.53 | 0.0098 |
| 4 | 0.08 | 306 | 4.50 | 1.08 | 28.50 | 17.00 | 1.46 | 0.71 | 1.53 | 0.0244 |
| 5 | 0.19 | 309 | 4.50 | 1.08 | 28.50 | 17.00 | 1.46 | 0.71 | 1.53 | 0.0590 |
| 6 | 0.27 | 333 | 4.50 | 1.08 | 28.50 | 17.00 | 1.46 | 0.71 | 1.53 | 0.0909 |
| 7 | 0.46 | 349 | 4.50 | 1.08 | 28.50 | 17.00 | 1.46 | 0.71 | 1.53 | 0.1601 |
| 8 | 0.52 | 376 | 4.50 | 1.10 | 28.50 | 17.00 | 1.48 | 0.72 | 1.53 | 0.1956 |
| 9 | 0.58 | 382 | 4.50 | 1.23 | 28.50 | 17.00 | 1.68 | 0.81 | 1.51 | 0.2229 |
| 10 | 0.28 | 35 | 4.50 | 2.29 | 28.50 | 17.00 | 3.27 | 1.59 | 1.45 | 0.0098 |
| 11 | 0.64 | 38 | 4.50 | 2.47 | 28.50 | 17.00 | 3.54 | 1.72 | 1.44 | 0.0244 |
| 12 | 1.34 | 44 | 4.50 | 2.93 | 28.50 | 17.00 | 4.22 | 2.05 | 1.43 | 0.0590 |
| 13 | 1.64 | 56 | 4.50 | 3.09 | 28.50 | 17.00 | 4.46 | 2.16 | 1.43 | 0.0909 |
| 14 | 1.84 | 87 | 4.50 | 2.85 | 28.50 | 17.00 | 4.10 | 1.99 | 1.43 | 0.1601 |
| 15 | 2.08 | 94 | 4.50 | 3.06 | 28.50 | 17.00 | 4.42 | 2.14 | 1.43 | 0.1956 |
| 16 | 1.75 | 127 | 4.50 | 2.81 | 28.50 | 17.00 | 4.04 | 1.96 | 1.43 | 0.2229 |
| 17 | 0.05 | 156 | 4.50 | 1.62 | 39.00 | 17.00 | 1.46 | 0.97 | 1.67 | 0.0082 |
| 18 | 0.14 | 169 | 4.50 | 1.62 | 39.00 | 17.00 | 1.46 | 0.97 | 1.67 | 0.0232 |
| 19 | 0.33 | 170 | 4.50 | 1.62 | 39.00 | 17.00 | 1.46 | 0.97 | 1.67 | 0.0561 |
| 20 | 0.47 | 184 | 4.50 | 1.62 | 39.00 | 17.00 | 1.46 | 0.97 | 1.67 | 0.0864 |
| 21 | 0.79 | 192 | 4.50 | 1.62 | 39.00 | 17.00 | 1.46 | 0.97 | 1.67 | 0.1521 |
| 22 | 0.90 | 207 | 4.50 | 1.64 | 39.00 | 17.00 | 1.48 | 0.98 | 1.67 | 0.1858 |
| 23 | 1.01 | 211 | 4.50 | 1.85 | 39.00 | 17.00 | 1.68 | 1.11 | 1.66 | 0.2117 |
| 24 | 0.47 | 17 | 4.50 | 3.53 | 39.00 | 17.00 | 3.27 | 2.17 | 1.63 | 0.0082 |
| 25 | 1.10 | 21 | 4.50 | 3.81 | 39.00 | 17.00 | 3.54 | 2.35 | 1.62 | 0.0232 |
| 26 | 2.30 | 24 | 4.50 | 4.53 | 39.00 | 17.00 | 4.22 | 2.80 | 1.62 | 0.0561 |
| 27 | 2.82 | 31 | 4.50 | 4.78 | 39.00 | 17.00 | 4.46 | 2.96 | 1.62 | 0.0864 |
| 28 | 3.17 | 48 | 4.50 | 4.40 | 39.00 | 17.00 | 4.10 | 2.72 | 1.62 | 0.1521 |
| 29 | 3.59 | 52 | 4.50 | 4.74 | 39.00 | 17.00 | 4.42 | 2.93 | 1.62 | 0.1858 |
| 30 | 3.02 | 70 | 4.50 | 4.34 | 39.00 | 17.00 | 4.04 | 2.68 | 1.62 | 0.2117 |

| | Maximum Power | | Energy Density | | Response | FOM | | | ESR |
|---|---|---|---|---|---|---|---|---|---|
| Example | Volumetric | Gravimetric | Volumetric | Gravimetric | Time | Volumetric | Gravimetric | Esr × Vol | thickness |
| # | (kW/l) | (kW/kg) | (Wh/l) | (Wh/kg) | (s) | (kW/l) | (kW/kg) | (ml · mΩ) | (mm · mΩ) |
| 1 | 78.03 | 47.16 | 0.54 | 0.33 | 0.0781 | 24.84 | 15.01 | 65 | 98 |
| 2 | 71.84 | 52.08 | 0.73 | 0.53 | 0.1149 | 22.87 | 16.58 | 70 | 145 |
| 3 | 22.41 | 14.65 | 0.12 | 0.08 | 0.0614 | 7.13 | 4.66 | 226 | 466 |
| 4 | 23.36 | 15.27 | 0.32 | 0.21 | 0.1532 | 7.44 | 4.86 | 217 | 447 |
| 5 | 23.16 | 15.14 | 0.76 | 0.50 | 0.3707 | 7.37 | 4.82 | 219 | 451 |
| 6 | 21.47 | 14.04 | 1.08 | 0.71 | 0.5712 | 6.84 | 4.47 | 236 | 487 |
| 7 | 20.53 | 13.42 | 1.83 | 1.19 | 1.0060 | 6.54 | 4.27 | 247 | 509 |
| 8 | 18.77 | 12.29 | 2.04 | 1.34 | 1.2290 | 5.98 | 3.91 | 270 | 557 |
| 9 | 16.28 | 10.78 | 2.02 | 1.33 | 1.4004 | 5.18 | 3.43 | 311 | 642 |
| 10 | 89.99 | 62.20 | 0.49 | 0.34 | 0.0614 | 28.64 | 19.80 | 56 | 116 |
| 11 | 77.09 | 53.47 | 1.04 | 0.72 | 0.1532 | 24.54 | 17.02 | 66 | 136 |
| 12 | 56.05 | 39.15 | 1.84 | 1.28 | 0.3707 | 17.84 | 12.46 | 90 | 186 |
| 13 | 42.18 | 29.52 | 2.13 | 1.49 | 0.5712 | 13.43 | 9.40 | 120 | 248 |
| 14 | 29.25 | 20.41 | 2.60 | 1.81 | 1.0060 | 9.31 | 6.50 | 173 | 357 |
| 15 | 25.14 | 17.59 | 2.73 | 1.91 | 1.2290 | 8.00 | 5.60 | 201 | 416 |
| 16 | 20.30 | 14.16 | 2.51 | 1.75 | 1.4004 | 6.46 | 4.51 | 249 | 515 |
| 17 | 33.50 | 20.08 | 0.15 | 0.09 | 0.0518 | 10.66 | 6.39 | 151 | 228 |
| 18 | 30.99 | 18.57 | 0.40 | 0.24 | 0.1455 | 9.86 | 5.91 | 163 | 246 |
| 19 | 30.72 | 18.41 | 0.96 | 0.57 | 0.3522 | 9.78 | 5.86 | 165 | 249 |
| 20 | 28.48 | 17.07 | 1.37 | 0.82 | 0.5426 | 9.07 | 5.43 | 178 | 268 |
| 21 | 27.23 | 16.32 | 2.30 | 1.38 | 0.9557 | 8.67 | 5.19 | 186 | 280 |
| 22 | 24.90 | 14.93 | 2.57 | 1.54 | 1.1675 | 7.92 | 4.75 | 203 | 307 |
| 23 | 21.59 | 13.02 | 2.54 | 1.53 | 1.3304 | 6.87 | 4.14 | 235 | 354 |
| 24 | 134.54 | 82.79 | 0.62 | 0.38 | 0.0518 | 42.82 | 26.35 | 38 | 57 |
| 25 | 102.24 | 63.01 | 1.32 | 0.81 | 0.1455 | 32.54 | 20.06 | 50 | 75 |
| 26 | 74.33 | 45.96 | 2.31 | 1.43 | 0.3522 | 23.66 | 14.63 | 68 | 103 |
| 27 | 55.94 | 34.62 | 2.68 | 1.66 | 0.5426 | 17.81 | 11.02 | 91 | 137 |
| 28 | 38.79 | 23.97 | 3.28 | 2.03 | 0.9557 | 12.35 | 7.63 | 131 | 197 |
| 29 | 33.35 | 20.63 | 3.44 | 2.13 | 1.1675 | 10.61 | 6.57 | 152 | 229 |
| 30 | 26.93 | 16.64 | 3.17 | 1.96 | 1.3304 | 8.57 | 5.30 | 188 | 284 |

| | | | Operating | | | | | | | Time |
|---|---|---|---|---|---|---|---|---|---|---|
| Example | Capacitance | Resistance | Voltage | Mass | L | W | H | Volume | Density | constant |
| # | (F) | (mΩ) | (V) | (g) | (mm) | (mm) | (mm) | (cm³) | (kg/l) | (s) |
| Side by | | | | | | | | | | |
| side cells | | | | | | | | | | |
| 31 | 0.03 | 319 | 4.50 | 1.08 | 28.50 | 34.00 | 0.69 | 0.67 | 1.62 | 0.0098 |
| 32 | 0.08 | 306 | 4.50 | 1.08 | 28.50 | 34.00 | 0.69 | 0.67 | 1.62 | 0.0244 |
| 33 | 0.19 | 309 | 4.50 | 1.08 | 28.50 | 34.00 | 0.69 | 0.67 | 1.62 | 0.0590 |
| 34 | 0.27 | 333 | 4.50 | 1.08 | 28.50 | 34.00 | 0.69 | 0.67 | 1.62 | 0.0909 |
| 35 | 0.46 | 349 | 4.50 | 1.08 | 28.50 | 34.00 | 0.70 | 0.68 | 1.60 | 0.1601 |
| 36 | 0.52 | 376 | 4.50 | 1.10 | 28.50 | 34.00 | 0.74 | 0.72 | 1.53 | 0.1956 |
| 37 | 0.58 | 382 | 4.50 | 1.23 | 28.50 | 34.00 | 0.84 | 0.81 | 1.51 | 0.2229 |
| 38 | 0.28 | 35 | 4.50 | 2.29 | 28.50 | 34.00 | 1.64 | 1.59 | 1.45 | 0.0098 |
| 39 | 0.64 | 38 | 4.50 | 2.47 | 28.50 | 34.00 | 1.77 | 1.72 | 1.44 | 0.0244 |
| 40 | 1.34 | 44 | 4.50 | 2.93 | 28.50 | 34.00 | 2.11 | 2.05 | 1.43 | 0.0590 |
| 41 | 1.64 | 56 | 4.50 | 3.09 | 28.50 | 34.00 | 2.23 | 2.16 | 1.43 | 0.0909 |
| 42 | 1.84 | 87 | 4.50 | 2.85 | 28.50 | 34.00 | 2.05 | 1.99 | 1.43 | 0.1601 |
| 43 | 2.08 | 94 | 4.50 | 3.06 | 28.50 | 34.00 | 2.21 | 2.14 | 1.43 | 0.1956 |
| 44 | 1.75 | 127 | 4.50 | 2.81 | 28.50 | 34.00 | 2.02 | 1.96 | 1.43 | 0.2229 |

| | Maximum Power | | Energy Density | | Response | FOM | | | ESR |
|---|---|---|---|---|---|---|---|---|---|
| Example | Volumetric | Gravimetric | Volumetric | Gravimetric | Time | Volumetric | Gravimetric | Esr × Vol | thickness |
| # | (kW/l) | (kW/kg) | (Wh/l) | (Wh/kg) | (s) | (kW/l) | (kW/kg) | (ml · mΩ) | (mm · mΩ) |
| Side by | | | | | | | | | |
| side cells | | | | | | | | | |
| 31 | 23.71 | 14.65 | 0.13 | 0.08 | 0.0614 | 7.55 | 4.66 | 214 | 220 |
| 32 | 24.72 | 15.27 | 0.33 | 0.21 | 0.1532 | 7.87 | 4.86 | 205 | 211 |
| 33 | 24.51 | 15.14 | 0.80 | 0.50 | 0.3707 | 7.80 | 4.82 | 207 | 213 |
| 34 | 22.72 | 14.04 | 1.15 | 0.71 | 0.5712 | 7.23 | 4.47 | 223 | 230 |
| 35 | 21.41 | 13.42 | 1.90 | 1.19 | 1.0060 | 6.62 | 4.27 | 236 | 244 |
| 36 | 18.77 | 12.29 | 2.04 | 1.34 | 1.2290 | 5.98 | 3.91 | 270 | 278 |
| 37 | 16.28 | 10.78 | 2.02 | 1.33 | 1.4004 | 5.18 | 3.43 | 311 | 321 |
| 38 | 89.99 | 62.20 | 0.49 | 0.34 | 0.0614 | 28.64 | 19.80 | 56 | 58 |
| 39 | 77.09 | 53.47 | 1.04 | 0.72 | 0.1532 | 24.54 | 17.02 | 66 | 68 |
| 40 | 56.05 | 39.15 | 1.84 | 1.28 | 0.3707 | 17.84 | 12.46 | 90 | 93 |
| 41 | 42.18 | 29.52 | 2.13 | 1.49 | 0.5712 | 13.43 | 9.40 | 120 | 124 |
| 42 | 29.25 | 20.41 | 2.60 | 1.81 | 1.0060 | 9.31 | 6.50 | 173 | 179 |
| 43 | 25.14 | 17.59 | 2.73 | 1.91 | 1.2290 | 8.00 | 5.60 | 201 | 208 |
| 44 | 20.30 | 14.16 | 2.51 | 1.75 | 1.4004 | 6.46 | 4.51 | 249 | 257 |

| | | | Operating | | | | | | | Time |
|---|---|---|---|---|---|---|---|---|---|---|
| Example | Capacitance | Resistance | Voltage | Mass | L | W | H | Volume | Density | constant |
| # | (F) | (mΩ) | (V) | (g) | (mm) | (mm) | (mm) | (cm³) | (kg/l) | (s) |
| Devices removing | | | | | | | | | | |
| the effect | | | | | | | | | | |
| of packaging | | | | | | | | | | |
| 45 | 0.22 | 57 | 4.50 | 1.36 | 39.00 | 17.00 | 1.29 | 0.86 | 1.59 | 0.0124 |
| 46 | 0.25 | 72 | 4.50 | 0.95 | 28.50 | 17.00 | 1.58 | 0.77 | 1.24 | 0.0183 |
| 47 | 0.03 | 319 | 4.50 | 0.68 | 28.50 | 17.00 | 1.02 | 0.49 | 1.38 | 0.0098 |
| 48 | 0.08 | 306 | 4.50 | 0.68 | 28.50 | 17.00 | 1.02 | 0.49 | 1.38 | 0.0244 |
| 49 | 0.19 | 309 | 4.50 | 0.68 | 28.50 | 17.00 | 1.02 | 0.49 | 1.38 | 0.0590 |
| 50 | 0.27 | 333 | 4.50 | 0.68 | 28.50 | 17.00 | 1.02 | 0.49 | 1.38 | 0.0909 |
| 51 | 0.46 | 349 | 4.50 | 0.68 | 28.50 | 17.00 | 1.02 | 0.49 | 1.38 | 0.1601 |
| 52 | 0.52 | 376 | 4.50 | 0.70 | 28.50 | 17.00 | 1.04 | 0.50 | 1.38 | 0.1956 |
| 53 | 0.58 | 382 | 4.50 | 0.83 | 28.50 | 17.00 | 1.24 | 0.60 | 1.38 | 0.2229 |
| 54 | 0.28 | 35 | 4.50 | 1.89 | 28.50 | 17.00 | 2.83 | 1.37 | 1.38 | 0.0098 |
| 55 | 0.64 | 38 | 4.50 | 2.07 | 28.50 | 17.00 | 3.10 | 1.50 | 1.38 | 0.0244 |
| 56 | 1.34 | 44 | 4.50 | 2.53 | 28.50 | 17.00 | 3.78 | 1.83 | 1.38 | 0.0590 |
| 57 | 1.64 | 56 | 4.50 | 2.69 | 28.50 | 17.00 | 4.02 | 1.95 | 1.38 | 0.0909 |
| 58 | 1.84 | 87 | 4.50 | 2.45 | 28.50 | 17.00 | 3.66 | 1.77 | 1.38 | 0.1601 |
| 59 | 2.08 | 94 | 4.50 | 2.66 | 28.50 | 17.00 | 3.98 | 1.93 | 1.38 | 0.1956 |
| 60 | 1.75 | 127 | 4.50 | 2.41 | 28.50 | 17.00 | 3.60 | 1.74 | 1.38 | 0.2229 |
| 61 | 0.05 | 156 | 4.50 | 1.08 | 39.00 | 17.00 | 1.02 | 0.68 | 1.59 | 0.0082 |
| 62 | 0.14 | 169 | 4.50 | 1.08 | 39.00 | 17.00 | 1.02 | 0.68 | 1.59 | 0.0232 |
| 63 | 0.33 | 170 | 4.50 | 1.08 | 39.00 | 17.00 | 1.02 | 0.68 | 1.59 | 0.0561 |
| 64 | 0.47 | 184 | 4.50 | 1.08 | 39.00 | 17.00 | 1.02 | 0.68 | 1.59 | 0.0864 |
| 65 | 0.79 | 192 | 4.50 | 1.08 | 39.00 | 17.00 | 1.02 | 0.68 | 1.59 | 0.1521 |
| 66 | 0.90 | 207 | 4.50 | 1.10 | 39.00 | 17.00 | 1.04 | 0.69 | 1.59 | 0.1858 |
| 67 | 1.01 | 211 | 4.50 | 1.31 | 39.00 | 17.00 | 1.24 | 0.82 | 1.59 | 0.2117 |
| 68 | 0.47 | 17 | 4.50 | 2.99 | 39.00 | 17.00 | 2.83 | 1.88 | 1.59 | 0.0082 |
| 69 | 1.10 | 21 | 4.50 | 3.27 | 39.00 | 17.00 | 3.10 | 2.06 | 1.59 | 0.0232 |
| 70 | 2.30 | 24 | 4.50 | 3.99 | 39.00 | 17.00 | 3.78 | 2.51 | 1.59 | 0.0561 |
| 71 | 2.82 | 31 | 4.50 | 4.24 | 39.00 | 17.00 | 4.02 | 2.67 | 1.59 | 0.0864 |
| 72 | 3.17 | 48 | 4.50 | 3.86 | 39.00 | 17.00 | 3.66 | 2.43 | 1.59 | 0.1521 |
| 73 | 3.59 | 52 | 4.50 | 4.20 | 39.00 | 17.00 | 3.98 | 2.64 | 1.59 | 0.1858 |
| 74 | 3.02 | 70 | 4.50 | 3.80 | 39.00 | 17.00 | 3.60 | 2.39 | 1.59 | 0.2117 |

| | Maximum Power | | Energy Density | | Response | FOM | | | ESR |
|---|---|---|---|---|---|---|---|---|---|
| Example | Volumetric | Gravimetric | Volumetric | Gravimetric | Time | Volumetric | Gravimetric | Esr × Vol | thickness |
| # | (kW/l) | (kW/kg) | (Wh/l) | (Wh/kg) | (s) | (kW/l) | (kW/kg) | (ml · mΩ) | (mm · mΩ) |
| Devices removing | | | | | | | | 0 | 0 |
| the effect | | | | | | | | | |
| of packaging | | | | | | | | | |
| 45 | 104.60 | 65.88 | 0.72 | 0.45 | 0.0781 | 33.30 | 20.97 | 48 | 73 |
| 46 | 91.85 | 74.01 | 0.93 | 0.75 | 0.1149 | 29.24 | 23.56 | 55 | 114 |
| 47 | 32.07 | 23.24 | 0.17 | 0.13 | 0.0614 | 10.21 | 7.40 | 158 | 326 |
| 48 | 33.44 | 24.23 | 0.45 | 0.33 | 0.1532 | 10.65 | 7.71 | 151 | 312 |
| 49 | 33.16 | 24.03 | 1.09 | 0.79 | 0.3707 | 10.55 | 7.65 | 153 | 315 |
| 50 | 30.74 | 22.27 | 1.55 | 1.12 | 0.5712 | 9.78 | 7.09 | 165 | 340 |
| 51 | 29.39 | 21.30 | 2.61 | 1.89 | 1.0060 | 9.35 | 6.78 | 172 | 356 |
| 52 | 26.71 | 19.36 | 2.90 | 2.10 | 1.2290 | 8.50 | 6.16 | 190 | 391 |
| 53 | 22.05 | 15.98 | 2.73 | 1.98 | 1.4004 | 7.02 | 5.09 | 230 | 474 |
| 54 | 103.97 | 75.34 | 0.56 | 0.41 | 0.0614 | 33.09 | 23.98 | 49 | 101 |
| 55 | 88.03 | 63.79 | 1.19 | 0.86 | 0.1532 | 28.02 | 20.30 | 58 | 119 |
| 56 | 62.56 | 45.33 | 2.05 | 1.49 | 0.3707 | 19.91 | 14.43 | 81 | 167 |
| 57 | 46.79 | 33.91 | 2.36 | 1.71 | 0.5712 | 14.90 | 10.79 | 108 | 223 |
| 58 | 32.76 | 23.74 | 2.91 | 2.11 | 1.0060 | 10.43 | 7.56 | 155 | 319 |
| 59 | 27.92 | 20.23 | 3.03 | 2.20 | 1.2290 | 8.89 | 6.44 | 181 | 374 |
| 60 | 22.79 | 16.51 | 2.82 | 2.04 | 1.4004 | 7.25 | 5.26 | 222 | 459 |
| 61 | 47.95 | 30.16 | 0.22 | 0.14 | 0.0518 | 15.26 | 9.60 | 106 | 159 |
| 62 | 44.35 | 27.90 | 0.57 | 0.36 | 0.1455 | 14.12 | 8.88 | 114 | 172 |
| 63 | 43.97 | 27.66 | 1.37 | 0.86 | 0.3522 | 14.00 | 8.80 | 115 | 174 |
| 64 | 40.77 | 25.64 | 1.96 | 1.23 | 0.5426 | 12.98 | 8.16 | 124 | 187 |
| 65 | 38.98 | 24.51 | 3.29 | 2.07 | 0.9557 | 12.41 | 7.80 | 130 | 196 |
| 66 | 35.43 | 22.28 | 3.66 | 2.30 | 1.1675 | 11.28 | 7.09 | 143 | 216 |
| 67 | 29.24 | 18.39 | 3.44 | 2.16 | 1.3304 | 9.31 | 5.85 | 173 | 261 |
| 68 | 155.44 | 97.76 | 0.71 | 0.45 | 0.0518 | 49.48 | 31.12 | 33 | 49 |
| 69 | 116.75 | 73.43 | 1.50 | 0.94 | 0.1455 | 37.16 | 23.37 | 43 | 65 |
| 70 | 82.97 | 52.18 | 2.58 | 1.63 | 0.3522 | 26.41 | 16.61 | 61 | 92 |
| 71 | 62.06 | 39.03 | 2.98 | 1.87 | 0.5426 | 19.75 | 12.42 | 82 | 123 |
| 72 | 43.45 | 27.33 | 3.67 | 2.31 | 0.9557 | 13.83 | 8.70 | 117 | 176 |
| 73 | 37.03 | 23.29 | 3.82 | 2.40 | 1.1675 | 11.79 | 7.41 | 137 | 206 |
| 74 | 30.22 | 19.01 | 3.55 | 2.24 | 1.3304 | 9.62 | 6.05 | 168 | 253 |

1. An energy storage device having at a plurality of energy storage cells that each include two terminals, adjacent terminals being engaged at junctions to connect the cells in series and the device including:
a first contact that is connected to one of the terminal of a first of the cells in the series;
a second contact that is connected to one of the terminals of a last of the cells in the series;
at least one intermediate contact that is connected to the respective junctions; and
resistive paths that extend between the contacts for collectively defining a resistive balance for the device.

2. A device according to claim 1 wherein at least one of the resistive paths includes conductive portions and resistive portions.

3. A device according to claim 2 wherein the resistive portions include a resistor.

4. A device according to claim 3 wherein the resistive portions comprise a resistor.

5. A device according to claim 2 wherein the resistive portions include one or more active components.

6. A device according to claim 5 wherein the resistive portions include a combination of one or more active components and one or more passive components.

7. A device according to claim 6 wherein the active devices include one or more of: an operational amplifier; a diode; a transistor; and another active device.

8. A device according to claim 7 wherein the passive device includes one or more of: a resistor; a capacitor; and another passive device.

9. A device according to claim 1 wherein at least one of the cells is a supercapacitive cell.

10. A device according to claim 9 wherein the supercapacitive cell is a carbon based supercapacitive cell.
